(19) United States
(12) Patent Application Publication
(10) Pub. No.: US 2018/0297288 A1
(43) Pub. Date: Oct. 18, 2018

(54) Systems And Methods For Extrusion Control In Three-Dimensional (3D) Printing

(71) Applicant: Desktop Metal, Inc., Burlington, MA (US)

(72) Inventors: Alexander C. Barbati, Cambridge, MA (US); Richard Remo Fontana, Cape Elizabeth, ME (US); John LaPlante, Concord, NH (US); Jonah Samuel Myerberg, Lexington, MA (US)

(21) Appl. No.: 15/949,488

(22) Filed: Apr. 10, 2018

Related U.S. Application Data
(60) Provisional application No. 62/485,722, filed on Apr. 14, 2017.

(51) Int. Cl. B29C 64/393; B29C 64/165; B29C 64/209; B33Y 10/00; B33Y 30/00; B33Y 50/02

(52) U.S. Cl. CPC B29C 64/393; B29C 64/165; B33Y 50/02; B33Y 10/00; B33Y 30/00; B29C 64/209

(57) ABSTRACT

Systems, methods, and apparatus are introduced for controlling an output flow of a build material from an extrusion assembly used for printing a three-dimensional (3D) object. Control of the output flow is based on an input control value that may be a function of a hydraulic capacitance and a hydraulic resistance, representing hydraulic capacitance values and hydraulic resistance values, respectively, associated with the build material, the extrusion assembly, or a combination thereof at one or more locations of the extrusion assembly relative to a melting zone of an extrusion head of the extrusion assembly as well as a target output flow. The input control value enables the output flow to match the target output flow. The hydraulic capacitance and resistance values account for interaction of the build material and a mechanical mechanism of the extrusion assembly driving extrusion of the build material. The hydraulic capacitance and resistance values may depend upon interaction between the build material and mechanics of the extrusion assembly as well as an internal wetted geometry of the extrusion assembly.

### RELATED APPLICATION

This application claims the benefit of U.S. Provisional Application No. 62/485,722, filed on Apr. 14, 2017. The entire teachings of the above application are incorporated herein by reference.

### BACKGROUND

Three-dimensional (3D) printing, also known as additive manufacturing (AM), may refer to processes used to create a 3D object in which successive layers of material are formed under computer control to create the 3D object. The 3D object may be of almost any shape or geometry and may be produced based on data from a computer aided design (CAD) model representing the 3D object, or any other suitable data.

An extrusion-based layered manufacturing machine may build up such a 3D object by extruding a build material, that may also be referred to interchangeably herein as a feedstock, filament, or media, from an extrusion head in a predetermined pattern onto a build surface, that may also be referred to interchangeably herein as a build plate, build platform, stage, base, or bed. The predetermined pattern may be determined based on the CAD model representing the 3D object, or any other suitable data.

The build material may be supplied to the extrusion head and the extrusion head may bring the build material to a flowable temperature to produce a flowable build material for deposition onto the build surface. A force of the incoming build material may cause extrusion of the flowable build material out from a nozzle of the extrusion head. The flowable build material may be extruded via the nozzle and adhere to a previously deposited build material with an adequate bond upon solidification.

A flow rate of the flowable build material being extruded from the nozzle may be a function of an advancement rate at which the build material is advanced to the extrusion head or pressure applied to advance the build material. The flow rate may be commanded by controlling the advancement rate via a controller that controls speed of a mechanism for advancing the build material or controls the pressure being applied to the build material. In addition to controlling the advancement rate, the controller may control movement of the extrusion head in a horizontal x, y plane, as well as movement of the build surface in a vertical z-direction. The controller may control the extrusion head movement relative to the 3D object being printed. For example, in some cases, the 3D object being printed may move in x and y, and the extrusion head may be stationary. By controlling such movements and the flow rate in synchrony, the flowable build material may be deposited onto the build surface layer-by-layer along tool paths that may be derived from the CAD model. The flowable build material being extruded may fuse to previously deposited build material and solidify to form the 3D object resembling the CAD model.

### SUMMARY

According to an example embodiment, a system for producing a three-dimensional (3D) object may comprise an extrusion assembly, the extrusion assembly including at least one actuator and an extrusion head, and a controller. The controller may be configured to control the at least one actuator to supply a build material to the extrusion head based on an input control value. The extrusion head may be configured to heat the build material within a melting zone of the extrusion head prior to extruding an output flow of the build material to produce the 3D object. The input control value may be a function of (i) a hydraulic capacitance and a hydraulic resistance, representing hydraulic capacitance values and hydraulic resistance values, respectively, associated with the build material, the extrusion assembly, or a combination thereof, at one or more locations of the extrusion assembly relative to the melting zone and (ii) a target output flow. The input control value may enable the output flow to match the target output flow.

The melting zone may be a region of the extrusion assembly within which the build material is deformed, irreversibly, due to an increase in temperature.

The input control value may be an input flow value or an input pressure value.

The hydraulic resistance values may each represent a respective change in pressure per change in flow rate of the build material at the one or more locations relative to the melting zone.

The hydraulic capacitance values may each represent a respective first amount of build material stored in the extrusion assembly per a second amount of pressure applied to the extrusion assembly at the one or more locations relative to the melting zone.

The hydraulic capacitance values may include a first hydraulic capacitance value and a second hydraulic capacitance value. The first hydraulic capacitance value may represent a first hydraulic capacitance of the extrusion assembly and the build material in a solid form prior to an entrance of the melting zone. The second hydraulic capacitance value may represent a second hydraulic capacitance of the extrusion assembly and the build material in a melted or partially melted form within the melting zone.

The hydraulic resistance values may include a first resistance value, second resistance value, and third resistance value. The first resistance value may represent a first resistance of the build material in a first melted or partially melted form within the melting zone. The second resistance value may represent a second resistance of the build material in a second melted or partially melted form further within the melting zone and closer to an exit of the melting zone relative to the first resistance. The third resistance value may represent a third resistance of the build material in a third melted or partially melted form following the exit of the melting zone and outside of the extrusion head.

The hydraulic capacitance values and hydraulic resistance values may be specific to at least one of: the extrusion assembly, a wetted geometry of the extrusion assembly, a characteristic of the build material, an ambient temperature surrounding and external to the extrusion assembly, a temperature of the build material within the extrusion assembly, a length of the build material in a solid form between the at least one actuator and the melting zone to be extruded from the extrusion assembly, or a diameter of the build material to be extruded from the extrusion assembly.

The hydraulic capacitance values and the hydraulic resistance values may be associated with capacitive and resistive elements, respectively, in a hydraulic circuit model.

The capacitive elements may include a first capacitive element and a second capacitive element. The hydraulic capacitance values may include a first hydraulic capacitance value and a second hydraulic capacitance value associated with the first and second capacitive elements, respectively. The first capacitive element associated with the first hydraulic capacitance value may represent a first hydraulic capacitance of the extrusion assembly and the build material in a solid form prior to an entrance of the melting zone. The second capacitive element associated with the second hydraulic capacitance value may represent a second hydraulic capacitance of the extrusion assembly and the build material in a melted or partially melted form within the melting zone.

The resistive elements may include a first resistive element, second resistive element, and third resistive element. The hydraulic resistance values may include a first resistance value, second resistance value, and third resistance value associated with the first, second, and third resistive elements, respectively. The first resistive element associated with the first resistance value may represent a first resistance of the build material in a first melted or partially melted form within the melting zone. The second resistive element associated with the second resistance value may represent a second resistance of the build material in a second melted or partially melted form further within the melting zone and closer to an exit of the melting zone relative to the first resistance. The third resistive element associated with the third resistance value may represent a third resistance of the build material in a third melted or partially melted form following the exit of the melting zone and outside of the extrusion head.

The hydraulic circuit model may represent a description of a response of the build material to an imposed stress resulting in motion or to an imposed motion resulting in stress that may be represented by the capacitance values and the resistance values.

The response may be a linear or non-linear response of the build material in a solid, liquefied, or semi-solid form.

The hydraulic circuit model may represent a description of an interaction of the build material in a solid, liquefied, or semi-solid form with a geometry of the extrusion assembly. The interaction may produce storage of the build material in the geometry as a function of imposed motion, imposed stress, or a combination thereof. The hydraulic capacitance values may each represent a respective first amount of build material stored in the extrusion assembly per a second amount of pressure applied to the extrusion assembly at the one or more locations relative to the melting zone.

The hydraulic circuit model may represent a description of compliant interactions of mechanisms of the extrusion assembly with the build material in a solid, liquefied, or semi-solid form. The compliant interactions may result in storage of the build material. The hydraulic capacitance values may each represent a respective first amount of build material stored in the extrusion assembly per a second amount of pressure applied to the extrusion assembly at the one or more locations relative to the melting zone.

The hydraulic circuit model may represent a linear or a non-linear description of the extrusion assembly and the build material.

The hydraulic circuit model may be configured to account for non-Newtonian type characteristics of the build material.

The hydraulic circuit model may include a first capacitive element, second capacitive element, first resistive element, second resistive element, and third resistive element. The first capacitive element may be coupled to a controlled volume generator, the first resistive element, and an ambient pressure; the second capacitive element may be coupled to the first resistive element and the second resistive element. The first resistive element may be coupled to the controlled volume generator, the first capacitive element, the second capacitive element, and the second resistive element; the second resistive element may be coupled to the first resistive element, second capacitive element, and third resistive element; and the third resistive element may be coupled to the second resistive element and the ambient pressure.

The first capacitive element may represent a first hydraulic capacitance of the extrusion assembly and the build material in a solid form prior to an entrance of the melting zone; the second capacitive element may represent a second hydraulic capacitance of the extrusion assembly and the build material within the melting zone; the first resistive element may represent a first resistance of the build material in a melted or partially melted form within the melting zone; the second resistive element may represent a second resistance of the build material in the melted or partially melted form further within the melting zone and closer to an exit of the melting zone relative to the first resistance; and the third resistive element may represent a third resistance of the build material in the melted or partially melted form following the exit of the melting zone.

The hydraulic resistance values may be determined based on measuring an efflux of mass or volume of the build material and a pressure within the extrusion assembly at a fixed set temperature and a forcing condition applied to the build material.

The hydraulic resistance values may be determined based on measuring a pressure within the extrusion assembly at a fixed set temperature and constant rates of influx of mass or volume of the build material.

The hydraulic capacitance values may be determined based on a measured line width of the build material produced along a build plate in response to a commanded variation of the output flow.

The system may further comprise an imaging system and the measured line width may be measured via the imaging system.

The hydraulic capacitance values may be determined prior to, during, or after printing of the 3D object.

The hydraulic resistance values may be determined prior to, during, or after printing of the 3D object.

The extrusion head may be configured to heat the build material within the melting zone via at least one heating element coupled to the extrusion head or via friction.

The friction may be: friction between the build material and an interior wall of the extrusion head, friction between the build material and an extrusion drive element configured to move within the extrusion head to extrude the build material, friction among constituents of the build material, or a combination thereof.

The controller may be further configured to receive a real-time measurement of the extrusion assembly and adjust the input control value based on the real-time measurement, the real-time measurement including a flow measurement, pressure measurement, printed line width measurement, or a combination thereof.

The controller may be further configured to receive a commanded profile for extruding the build material along a build surface and to modify the commanded profile based on a hydraulic circuit model of the extrusion assembly, application of the hydraulic capacitance values, the hydraulic resistance values, the target output flow to the hydraulic circuit model, and real-time data of the extrusion assembly.

The real-time data may include at least one of: an ambient temperature of the extrusion assembly, a temperature of the build material within the extrusion assembly, first length of the build material in solid form within the extrusion assembly, second length of the build material to be extruded from the extrusion assembly, or a diameter of the build material to be extruded from the extrusion assembly.

The controller may be further configured to receive at least one toolpath command for controlling movement of the extrusion assembly along the build plate and to adjust the at least one toolpath command based on the input control value.

The controller may be a local controller.

The controller may be a remote controller.

According to another example embodiment, a method for controlling extrusion of a build material for producing a three-dimensional (3D) object may comprise controlling at least one actuator of an extrusion assembly to supply the build material to an extrusion head of the extrusion assembly based on an input control value, heating the build material within a melting zone of the extrusion head prior to extruding an output flow of the build material to produce the 3D object. The input control value may be a function of (i) a hydraulic capacitance and a hydraulic resistance, representing hydraulic capacitance values and hydraulic resistance values, respectively, associated with the build material, an extrusion assembly, or a combination thereof at one or more locations of the extrusion assembly relative to a melting zone and (ii) a target output flow, the input control value enabling the output flow to match the target output flow.

Alternative method embodiments parallel those described above in connection with the example system embodiment.

According to yet another example embodiment, a system for producing a three-dimensional (3D) object may comprise means for controlling at least one actuator of an extrusion assembly to supply a build material to an extrusion head of the extrusion assembly based on an input control value and means for heating the build material within a melting zone of the extrusion head prior to extruding an output flow of the build material to produce the 3D object. The input control value may be a function of (i) a hydraulic capacitance and a hydraulic resistance, representing hydraulic capacitance values and hydraulic resistance values, respectively, associated with the build material, an extrusion assembly, or a combination thereof at one or more locations of the extrusion assembly relative to a melting zone and (ii) a target output flow, the input control value enabling the output flow to match the target output flow.

It should be understood that example embodiments disclosed herein can be implemented in the form of a method, apparatus, system, or computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an example embodiment of a system for producing a produce a three-dimensional (3D) object.

FIG. 2 is a block diagram of an example embodiment of a hydraulic circuit model superimposed on an extrusion assembly.

FIG. 3 is a circuit diagram of an example embodiment of another hydraulic circuit model.

FIG. 4 is a flow diagram of an example embodiment of a method for controlling extrusion of a build material for producing a three-dimensional (3D) object.

FIG. 5A is a graph of an example embodiment of over-extrusion.

FIG. 5B is a graph of log values of normalized line widths of line widths of the graph of FIG. 5A over time.

FIG. 5C is a graph of normalized line widths 505 of the line widths of the graph of FIG. 5A over time.

FIG. 6 is a block diagram of an example embodiment of a control system for a 3D printing system.

FIG. 7 is a block diagram of another example embodiment of a control system for a 3D printing system.

FIG. 8A is circuit diagram of an example embodiment of a non-linear model.

FIG. 8B is a graph of an example embodiment of the first pressure drop of FIG. 8A based on feedstock flow rate.

FIG. 8C is a graph of an example embodiment of the second pressure drop of FIG. 8A based on feedstock flow rate.

FIG. 9 is a graph of an example embodiment of normalized line widths over time.

FIG. 10 is a graph of an example embodiment of commanded step changes in line width that may be used to generate print lines of extrudate with rapidly varying width.

FIG. 11A is a plot of an example embodiment of printed geometry in response to the commanded step changes of FIG. 10.

FIG. 11B is a magnified view of a section of the printed geometry of FIG. 11A.

FIG. 12 is a graph of an example embodiment commanded profiles that may be employed to determine parameters of a hydraulic circuit model.

FIG. 13 is a graph of an example embodiment of line widths for three segments of extrudate.

FIG. 14A is a graph of an example embodiment of log of normalized line width over time for a stage speed of 10 mm/s.

FIG. 14B is a graph of an example embodiment of normalized line width over time for the stage speed of 10 mm/s.

FIG. 14C is a graph of an example embodiment of log of normalized line width over time for a stage speed of 20 mm/s.

FIG. 14D is a graph of an example embodiment of normalized line width over time for the stage speed of 20 mm/s.

FIG. 14E is a graph of an example embodiment of log of normalized line width over time for a stage speed of 30 mm/s.

FIG. 14F is a graph of an example embodiment of normalized line width over time for the stage speed of 30 mm/s.

FIG. 14G is a graph of an example embodiment of log of normalized line width over time for a stage speed of 40 mm/s.

FIG. 14H is a graph of an example embodiment of normalized line width over time for the stage speed of 40 mm/s.

FIG. 15A is a graph of an example embodiment of line width relative to position on a stage for a stage speed of 10 mm/s.

FIG. 15B is a graph of an example embodiment of line width deviation from an average over time for the stage speed of 10 mm/s.

FIG. 15C is a graph of an example embodiment of line width relative to position on a stage for a stage speed of 40 mm/s.

FIG. 15D is a graph of an example embodiment of line width deviation from an average over time for the stage speed of 40 mm/s.

FIG. 15E is block diagram of an example embodiment of a long transient.

FIG. 16A is a graph of an example embodiment of line width of extrudate relative to a position on a stage with a speed of 10 mm/s.

FIG. 16B is a graph of an example embodiment of line width of extrudate relative to a position on a stage with a speed of 20 mm/s.

FIG. 16C is a graph of an example embodiment of line width of extrudate relative to a position on a stage with a speed of 30 mm/s.

FIG. 16D is a graph of an example embodiment of line width of extrudate relative to a position on a stage with a speed of 40 mm/s.

FIG. 17A is graph of an example embodiment of line width of extrudate at a position on a stage.

FIG. 17B is a graph of an example embodiment of normalized line width of FIG. 17A over time.

FIG. 17C is graph of another example embodiment of line width of extrudate at a position on a stage.

FIG. 17D is a graph of an example embodiment of normalized line width of FIG. 17C over time.

FIG. 17E is graph of another example embodiment of line width of extrudate at a position on a stage.

FIG. 17F is a graph of an example embodiment of normalized line width of FIG. 17E over time.

FIG. 17G is graph of another example embodiment of line width of extrudate at a position on a stage.

FIG. 17H is a graph of an example embodiment of normalized line width of FIG. 17G over time.

FIG. 18A is a graph of an example embodiment of a flow in command over time.

FIG. 18B is a graph of an example embodiment of flow out, computed, over time.

FIG. 18C is a graph of an example embodiment of total in/out flow over time.

FIG. 18D is a graph of another example embodiment of a flow in command over time.

FIG. 18E is a graph of another example embodiment of flow out, computed, over time.

FIG. 18F is a graph of another example embodiment of total in/out flow over time.

FIG. 18G is a graph of yet another example embodiment of a flow in command over time.

FIG. 18H is a graph of yet another example embodiment of flow out, computed, over time.

FIG. 18I is a graph of yet another example embodiment of total in/out flow over time.

FIG. 19A is a graph of yet another example embodiment of a flow in command over time.

FIG. 19B is a graph of yet another example embodiment of flow out, computed, over time.

FIG. 19C is a graph of yet another example embodiment of total in/out flow over time.

FIG. 20 is a block diagram of an example internal structure of a computer optionally within an embodiment disclosed herein.

### DETAILED DESCRIPTION

A description of example embodiments of the invention follows.

According to an example embodiment, a method for controlling extrusion of a build material from an extrusion assembly (also referred to interchangeably herein as an extruder) may produce an input flow rate of the build material which depends upon a desired (i.e., target) flow rate of the build material at the nozzle and several resistance and capacitance parameters with values based on interaction of the build material to be extruded and a mechanical mechanism driving such extrusion.

The resistance and capacitance parameters may be parameters of a linear or non-linear description (also referred to interchangeably herein as a linear or non-linear hydraulic circuit model or linear or non-linear model) that may be configured to model, that is, simulate, an extrusion assembly and a build material being extruded via same. Such a linear or non-linear model may be used to determine an input control value for advancing the build material into the extrusion assembly in order to achieve a desired (i.e., target) output flow of the build material from the extrusion assembly.

The linear or non-linear model may be formulated to produce a flow, displacement, or pressure (i.e., force or strain) input control value or a pressure/force input control value that achieves a desired (i.e., target) output flow for a particular extrusion assembly and build material over a given period of time. The input control value may be used to revise a commanded input flow, displacement, or pressure value to produce a revised input flow, displacement, or pressure value. By accounting for interaction between the build material and mechanics of the extrusion assembly, as well as an internal wetted geometry of the extrusion assembly, an example embodiment may enable an output flow of the build material that matches the desired output flow. By accounting for such interaction, over- and under-extrusion, of the build material relative to a target, that would otherwise be exhibited from a nozzle of the extrusion assembly, may be obviated.

Geometric dimensions of printed lines on a build surface used for three-dimensional (3D) printing of a 3D object may respond in a undesirable way to variations in speed and direction of stage motors (x- and y-direction) and an actuator of an extrusion assembly. Such undesirable behavior, that is, over- or under-extrusion of a build material used for the printing, may most clearly manifest in response to step changes in flow command, such as start and stop conditions, and in response to commands for producing corner features that may cause the extrusion assembly to dwell or accelerate rapidly during the printing. As such, an output flow of the build material being extruded from the extrusion assembly may not match a desired (i.e., target) output flow. According to an example embodiment, control of at least one actuator supplying the build material to the extrusion head may be based on an input control value. The input control value may enable the output flow to match the target flow, allowing for improved extrusion control of the build material relative to controlling the at least one actuator based on a commanded flow or commanded pressure that is not based on the input control value determined as disclosed herein. The input control value may be an input flow value or an input pressure value.

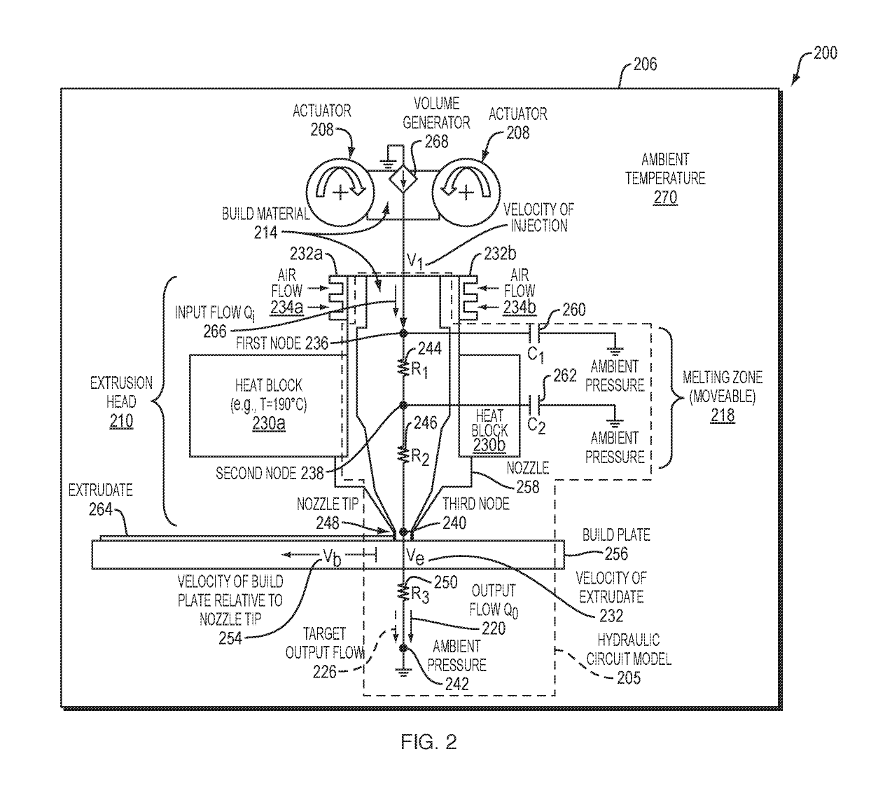

According to an example embodiment, a system, method, or apparatus may account for over- and under-extrusion of the build material (i.e., feedstock or media) through a nozzle tip, such as the nozzle tip 248 of FIG. 2, disclosed further below. According to an example embodiment, compression of the media (i.e., build material or feedstock) may be represented as pressure and mass storage elements in a hydraulic circuit model of an extrusion assembly that may be used to determine the input control value. The hydraulic circuit model is based on an understanding that a mechanical mechanism for forcing a solid form of the build material, such as a rod, and extrudate possesses a mechanical compliance. The hydraulic circuit model may be applied to systems in which the feedstock (which could be rod-like or coiled) is driven by smoothed, textured, or geared rollers and/or approaches where the rod is pushed along its axis using a kinematic mechanism. An example embodiment of a hydraulic circuit model identifies and quantifies both a non-Newtonian rheology of the partially melted or melted feedstock in the extrusion head (also referred to interchangeably herein as a hot-end) to indicate how pressure in the melted or partially melted feedstock is related to a desired extrusion speed of the media. An example embodiment of a hydraulic circuit model relates hydraulic resistance and mechanical capacitances and compliances in response to commanded flow signals to an actuator and determines a realized flow through an extrusion mechanism.

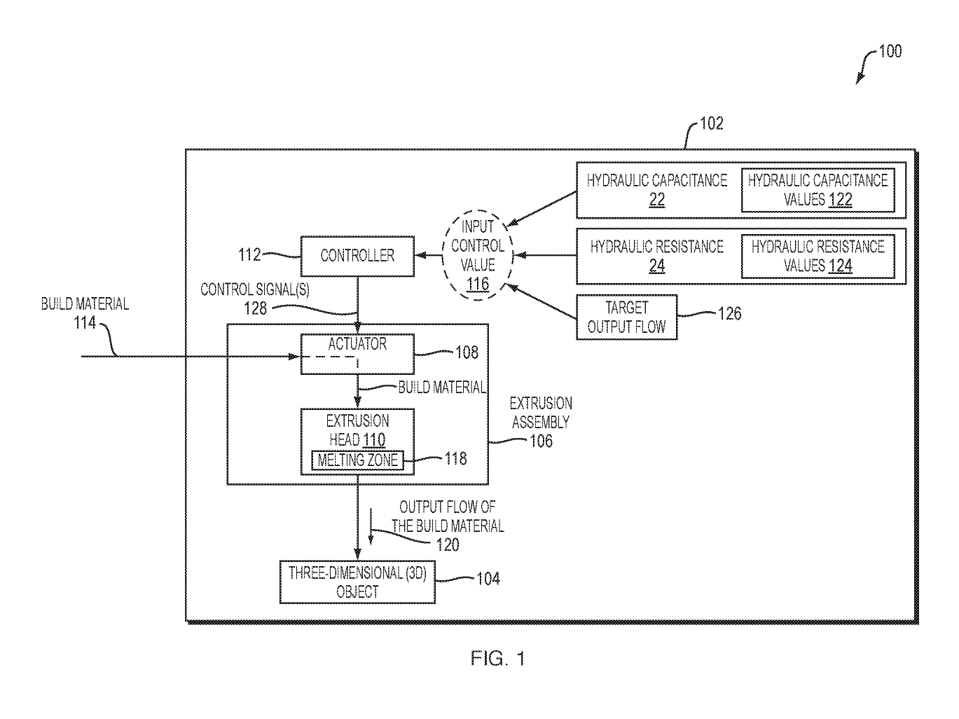

FIG. 1 is a block diagram 100 of an example embodiment of a system 102 for producing a three-dimensional (3D) object 104. The system comprises an extrusion assembly 106 that includes at least one actuator 108 and an extrusion head 110. The system 102 comprises a controller 112. The controller 112 is configured to control the at least one actuator 108 to supply a build material 114 to the extrusion head 110 based on an input control value 116. The extrusion head 110 is configured to heat the build material 114 within a melting zone 118 of the extrusion head 110 prior to extruding an output flow 120 of the build material 114 to produce the 3D object 104. The input control value 116 may be a function of (i) a hydraulic capacitance 22 and a hydraulic resistance 24, representing hydraulic capacitance values 122 and hydraulic resistance values 124, respectively, associated with the build material 114, the extrusion assembly 106, or a combination thereof at one or more locations of the extrusion assembly 106 relative to the melting zone 118 and (ii) a target output flow 126. The input control value 116 enables the output flow 120 to match the target output flow 126.

The hydraulic capacitance values 122 and hydraulic resistance values 124 associated with the build material 114, the extrusion assembly 106, or a combination thereof may be a function of environmental variables (not shown), such as an ambient temperature surrounding and external to the extrusion assembly 106, a temperature of the build material 114 within the extrusion assembly 106, or any other suitable environmental variables.

The extrusion head 110 is configured to receive the build material 114 and heat the build material 114 to a target extrusion temperature for the extrusion. It should be understood that the build material 114 may not truly “melt” since it may be a mixture of metal and polymer in which the metal doesn't melt but the polymer does. The mixture may be any suitable mixture for printing the 3D object 104, such as ceramic in polymer, or any other suitable mixture. The polymer may include multiple species each with its own melting point. The target extrusion temperature may be such that not all polymers are in a molten state during extrusion. Such heating may be within the melting zone 118 that may be a region of the extrusion head 110, also referred to interchangeably herein as a hot-end, where the build material 114 actuated into the hot-end is heated and, therefore, starts to melt. The melting zone 118 may be a moveable region within which the build material 114 deforms irreversibly due to temperature change. The melting zone 118 may be moveable due to changes in temperature or rate of actuation within the extrusion assembly 106 or due to any other suitable condition.

The extrusion head 110 may be configured to heat the build material 114 within the melting zone 118 via at least one heating element (not shown) coupled to the extrusion head 110 or via friction. The friction may be: friction between the build material 114 and an interior wall (not shown) of the extrusion head 110, friction between the build material 114 and an extrusion drive element (not shown) configured to move within the extrusion head 110 to extrude the build material 114, friction among constituents (not shown) of the build material 114 (i.e., viscous dissipation due to shear), or a combination thereof. The extrusion head 110 may be configured to heat the build material 114 via the at least one heating element, friction, or via any other suitable mechanism for heating the build material 114.

Molten build material may be deposited from a nozzle (not shown) of the extrusion head 110 in beads (not shown), or any in other suitable form, onto a planar base (not shown), such as the build plate 256 of FIG. 2, disclosed further below. The build material 114 may be a flexible filament, or any other suitable form of build material, such as a continuous solid material (e.g., a filament on a spool), liquid material, semi-solid slurry, a series of rods fed sequentially, a solid granular material, or any other suitable material. A spool (not shown) may carry a coil of filament that may be mounted on a spindle (not shown).

The least one actuator 108 may be any suitable mechanism for advancing the build material 114 into the extrusion head 110. For example, the at least one actuator 108 may comprise a pair of feed rollers (not shown) driven by a motor (not shown) that advances the build material 114 into the extrusion head 110 at a controlled rate. Alternatively, the at least one actuator 108 may comprise a controlling mechanism such as a finger (not shown) for pushing the build material along an axis of the build material 114 and down into the extrusion head 110. The at least one actuator 108 may comprise a valve (not shown) that controls release of a pressure from a pressure source (not shown) that forces the build material 114 into the extrusion head 110. The at least one actuator 108 may include a plurality of actuators (not shown). For example, a first actuator (not shown) of the plurality of actuators may perform coarse control of advancement for the build material 114, whereas a second actuator (not shown), of the plurality of actuators, may perform fine and fast control relative to control performed by the first actuator.

The extrusion head 110 may be pressurized by “pumping” the build material 114 into the extrusion head 110 by the at least one actuator 108. The build material 114 may act as a piston. The pressurization may impel a molten form of the build material 114 out of the nozzle (not shown). The output flow 120 of the build material 114 may be controlled by adjusting the at least one actuator 108. For example, the controller 112 may be configured to adjust a speed of rotation of the pair of feed rollers (not shown) or to adjust the actuator 108 in any other suitable way. The controller 112 may be configured to control the output flow 120 of the build material 114 by driving control signal(s) 128 to the at least one actuator 108. For example, the controller 112 may drive the control signal(s) 128 that may control a motor (not shown) configured to drive a feed roller (not shown) of the at least one actuator 108, or may drive any other suitable control signal that causes the at least one actuator 108 to advance the build material 114.

The extrusion head 110 may be driven along tool paths (not shown) in a horizontal x-y plane by an x-y translator (not shown) that may receive drive signals from the controller 112 in accordance with design data derived from a computer aided design (CAD) model (not shown) that represents the 3D object 104. As the extrusion head 110 is translated in the x-y plane, molten build material may be controllably dispensed from the nozzle (not shown) layer-by-layer onto the planar base (not shown). After each layer is dispensed, the planar base may be lowered a predetermined increment along a vertical z-axis by a z-axis translator (not shown), which may also receive drive signals from the controller 112. The dispensed build material may fuse and solidify to form the 3D object 104 resembling the CAD model. The build material 114 may be used to build a support structure (not shown) that may be dispensed in a like fashion in coordination with the dispensing of build material 114 used to build up the 3D object 104, to support portions of the 3D object 104 as it is under construction.

Fluidic and mechanical capacitances and non-linear resistances of the extrusion assembly 106 may produce a flow of the build material 114 from the extrusion assembly 106 that is different from a commanded flow. Generally, a response (or flow) from the extrusion assembly 106 may lag behind a target flow that is commanded on the actuator 108 moving the feedstock. Physically, this lag results from a storage of displacement in un-melted feedstock which is compressed by a force required to drive the flowable feedstock that may be in a semi-solid or fluid form through the extrusion assembly 106 in addition to the mechanical compliance of the extruder assembly 106 which may be both be loaded (in the case of increasing force on the feedstock and) and unloaded (in the case of decreasing force on the feedstock and flow). The mechanical compliance may be a deflection in the extrusion assembly, or any other suitable mechanical compliance.

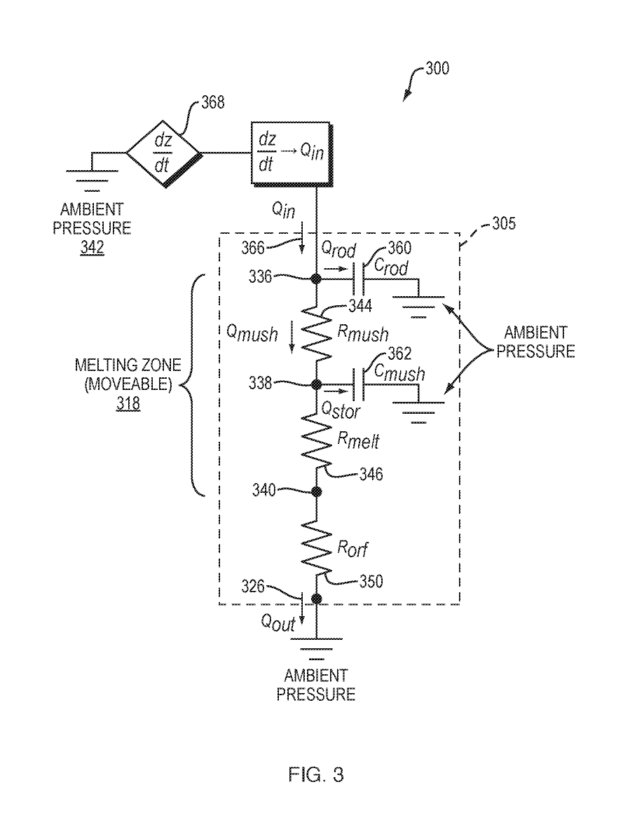

According to an example embodiment, a hydraulic circuit model, such as the hydraulic circuit models of FIG. 2 and FIG. 3, disclosed further below, may be configured to account for non-Newtonian type characteristics of the build material 114. For a case of a non-Newtonian material, a combination of a capacitance and non-linear resistance may produce a response that decays faster than an exponential at short times, and slower than exponential at long times. Such a response may be due to the non-Newtonian (shear thinning) nature of a particle-laden polymeric feedstock. Particle-laden polymeric feedstock materials are less resistive to flow, that is, such particle-laden polymeric feedstock materials have a lower viscosity when a shear rate imposed upon the material is large. Conversely, as the shear rate decreases (as occurs when the pressure is nearly all relieved) the particle-laden polymeric feedstock becomes increasingly resistive, and longer times are required for the built-up pressure to dissipate resulting in prolonged print errors.

To mitigate such effects, an example embodiment may relieve and preemptively prime pressure on the build material 114 during changes in the commanded flow rate. An example embodiment may consider non-linearity and capacitance of the build material 114 in solid form, instead of considering the build material 114 as having constant resistance (Newtonian) and accounting for capacitance in the melt only.

An example embodiment may model the extrusion assembly 106 and produce optimal (i.e., target) profiles to actuate the extrusion head 110. A model of the extrusion assembly may employ an electrical analogy such as disclosed with regard to FIG. 2 and FIG. 3, further below. While resistances may be shown as linear elements, an example embodiment may generalize such resistances to a non-linear case owing to the non-Newtonian characteristics of the build material 114 in a melted or partially melted form, as disclosed below.

An example embodiment may take into account the non-Newtonian nature of the build material 114 in the melted or partially melted form. An example embodiment may consider the compression of the build material 114 in solid form as producing capacitive effects as opposed to compressibility of the build material 114 in a melted or partially melted form or the thermal expansion of the media, that is, the build material 114.

An example embodiment of a method for controlling extrusion of the build material 114 may produce the input control value 116, that may be a revised input flow rate or revised input pressure, that is revised relative to an initially commanded input flow rate or pressure, and which may be based on the target output flow rate 126 at a nozzle (not shown) of the extruder assembly 106, and the hydraulic resistance values 122 and the hydraulic capacitance values 124 which may account for interaction of the build material 114 to be extruded and a mechanical mechanism driving extrusion. The hydraulic resistance values 122 and the hydraulic capacitance values 124 may depend upon an interaction between the build material 114 and the mechanical mechanism, as well as an internal wetted geometry of the extrusion assembly, that is, a geometry of the extrusion assembly 106 that comes into contact with the build material 114 as it passes through the extrusion assembly 106.

As disclosed above, the controller 112 may be configured to control the at least one actuator 108 to supply the build material 114 to the extrusion head 110 based on the input control value 116. The input control value 116 may be a function of (i) the hydraulic capacitance values 122 and hydraulic resistance values 124 associated with the build material 114, the extrusion assembly 106, or a combination thereof at the one or more locations relative to the melting zone 118 and (ii) the target output flow 126. According to an example embodiment, the hydraulic resistance values 124 may each represent a respective change in pressure per change in flow rate of the build material 114 at the one or more locations relative to the melting zone 118. The hydraulic capacitance values 122 may each represent a respective first amount of build material stored in the extrusion assembly 106 per a second amount of pressure applied to the extrusion assembly 106 at the one or more locations relative to the melting zone 118. Such hydraulic resistance values 124 and hydraulic capacitance values 122 may be associated with capacitive and resistive elements, such as the first hydraulic capacitance C1 260, second hydraulic capacitance C2 262, first resistance R1 244, second resistance R2 246, and third resistance R3 250, disclosed below with reference to the hydraulic circuit model 205 of FIG. 2. The first hydraulic capacitance C1 260 and the second hydraulic capacitance C2 262 are storage elements that may be inactive for constant flow of the build material 114 through the extrusion assembly 206.

FIG. 2 is a block diagram 200 of an example embodiment of a hydraulic circuit model 205 superimposed on an extrusion assembly 206, such as the extrusion assembly 106 of FIG. 1, disclosed above. The hydraulic circuit model 205 includes a controlled volume generator 268, first resistance R1 244, second resistance R2 246, third resistance R3 250, first hydraulic capacitance C1 260, second hydraulic capacitance C2 262, an ambient pressure 242. The hydraulic circuit model 205 may be employed by a processor (not shown) to determine an input flow Qᵢₙ 266 of a build material 214 supplied to the extrusion assembly 206 to achieve a target output flow Qₒᵤₜ 226 of the build material 214, as disclosed further below. The input flow Qᵢₙ 266 that is determined may serve as the input control value 116 of FIG. 1, disclosed above. It should be understood that the hydraulic circuit model 205 may be drawn as an equivalent circuit (not shown) with the hydraulic capacitance 22 and the hydraulic resistance 24, that is, with a single capacitance and a single resistance in the equivalent circuit.

The extrusion assembly 206 includes at least one actuator 208 and an extrusion head 210. In the example embodiment of FIG. 2, the extrusion head 210 is coupled to heat blocks 230a and 230b for heating the build material 214; however, as disclosed above, the extrusion head 210 may be configured to heat the build material 214 in any suitable way. The extrusion head 210 may be coupled to cooling fins 232a and 232b that focus air flow 234a and 234b to ensure a solid form of the build material 214 entering the extrusion head 210. However, it should be understood that maintaining the build material 214 at a particular temperature to ensure a solid form of the material entering the extrusion head 210 may be performed in any suitable way.

A controller (not shown), such as the controller 112 of FIG. 1, disclosed above, may be configured to control the at least one actuator 208 to supply the build material 214 to the extrusion head 210 based on an input control value (not shown), such as the input control value 116 of FIG. 1, disclosed above. The input control value may be a function of (i) the hydraulic capacitance values and hydraulic resistance values, such as the first resistance R1 244, second resistance R2 246, and third resistance R3 250, and the first hydraulic capacitance C1 260 and second hydraulic capacitance C2 262, respectively, that are associated with the build material 214, the extrusion assembly 210, or a combination thereof at the one or more locations relative to the melting zone 218 and (ii) the target output flow Qₒᵤₜ 226. According to an example embodiment, the hydraulic resistance values may each represent a respective change in pressure per change in flow rate of the build material 214 at the one or more locations relative to the melting zone 218, such as the locations at a first node 236, second node 238, and third node 240 of the hydraulic circuit model 205.

For example, the hydraulic resistance values may represent a respective change in pressure per change in flow rate of the build material 214 between the first node 236 and the second node 238, the second node 238 and the third node 240, and the third node 240 and an ambient pressure 242, where the first node 236 is at an entrance of the melting zone 218, the second node 238 is within the melting zone 218, and the third node 240 is at an exit of the melting zone 218.

The hydraulic resistance values may include a first resistance value, a second resistance value, and a third resistance value. The first resistance value may represent the first resistance R1 244 of the build material 214 that may be in a first melted or partially melted form within the melting zone 218. The second resistance value may represent the second resistance R2 246 of the build material 214 that may be in a second melted or partially melted form further within the melting zone 218 and closer, relative to the first resistance R1 244, to an exit, such as the nozzle tip 248, of the melting zone 218.

The third resistance value may represent the third resistance R3 250 of the build material 214 that may be in a third melted or partially melted form following the exit of the melting zone 218 and outside of the extrusion head 210. In FIG. 2, Vₑ 252 represents a velocity of an extrudate of the build material 214 following the exit of the melting zone 218 via the nozzle tip 248 and V_{b} 254 represents a velocity of a build plate 256 (also referred to interchangeably herein as a bed or stage) that may be a planar surface, as disclosed above, where V_{b} 254 represents the velocity of the build plate 256 relate to the nozzle tip 248 of a nozzle 258 of the extrusion head 210.

The hydraulic capacitance values may each represent a respective first amount of build material 214 stored in the extrusion assembly 206 per a second amount of pressure applied to the extrusion assembly 206 at the one or more locations relative to the melting zone 218. The hydraulic capacitance values may include a first hydraulic capacitance value and a second hydraulic capacitance value. The first hydraulic capacitance value may represent the first hydraulic capacitance C1 260 of the extrusion assembly 206 and the build material 214 in a solid form prior to an entrance of the melting zone 218. The second hydraulic capacitance value may represent the second hydraulic capacitance C2 262 of the extrusion assembly 206 and the build material 214 in a melted or partially melted form within the melting zone 218.

The hydraulic resistance values may be determined based on measuring a pressure within the extrusion assembly 206 at a fixed set temperature and constant rates of influx of mass or volume of the build material 214, such as by measuring the pressure at the first node 236, second node 238, or third node 240, or a combination thereof. The hydraulic resistance values may be determined based on measuring an efflux of mass or volume of the build material 214 and a pressure within the extrusion assembly 206 at a fixed set temperature and forcing condition applied to the build material 214, such as by measuring the efflux and pressure at the first node 236, second node 238, or third node 240, or a combination thereof. Further disclosure related to determining such values is disclosed, further below.

The hydraulic capacitance values may be determined based on a measured line width of the extrudate 264 of the build material 214 produced along the build plate 256 in response to a commanded variation of the output flow Qₒᵤₜ 220. Further disclosure related to determining such values is disclosed, further below.

Turning back to FIG. 1, the system 102 may further comprise an imaging system (not shown) and the measured line width may be measured via the imaging system. For example, one or more cameras may be coupled to the extrusion head 110 for capturing images used to determine such line width, or any other suitable imaging system or other system may be employed for determining same. The system 102 may further comprise at least one pressure sensor (not shown) employed for determining pressure measurements to enable determination of pressure.

The hydraulic capacitance values 122 and the hydraulic resistance values 124 may be determined prior to, during, or after printing of the 3D object 104. For example, such hydraulic capacitance or resistance values may be determined during a calibration phase that transpires before or after printing of the 3D object 104. Alternatively, such hydraulic capacitance or resistance values may be determined concurrent with printing of the 3D object 104. Alternatively, such hydraulic capacitance or resistance values may be static values. As such, it should be understood that the hydraulic capacitance values 122 and the hydraulic resistance values 124 may be predetermined values that are static over time or may be values that are dynamic, varying over time with respect to real-time data of the extrusion assembly 106, and that such dynamic hydraulic capacitance and resistance values may be computed, dynamically, with respect to the printing of the 3D object 104.

The hydraulic capacitance values 122 and the hydraulic resistance values 124 may be specific to at least one of: the extrusion assembly 106, a wetted geometry of the extrusion assembly 106, a characteristic of the build material 114, an ambient temperature surrounding and external to the extrusion assembly 106, a temperature of the build material 114 within the extrusion assembly 106, a length of the build material 114 in a solid form between the at least one actuator 108 and an entrance to the melting zone 118, or a diameter of the build material 114 in solid form.

The characteristic of the build material 114 may be a feedstock dimension, viscosity, Young's modulus, or any other suitable characteristic. The wetted geometry may be a geometry of the extrusion assembly 106 that comes into contact with the build material 114 as it passes through the extrusion assembly 106

The hydraulic capacitance values 122 and the hydraulic resistance values 124 may be associated with capacitive and resistive elements, such as the first hydraulic capacitance C1 260, second hydraulic capacitance C2 262, first resistance R1 244, second resistance R2 246, and third resistance R3 250, disclosed above with reference to the hydraulic circuit model 205 of FIG. 2. Turning back to FIG. 2, the hydraulic circuit model 205 may represent a description of a response of the build material 214 to an imposed stress resulting in motion or to an imposed motion resulting in stress that may be represented by the capacitance values and the resistance values. The response may be a non-linear or linear response of the build material 214 in a solid, liquefied, or semi-solid form.

For example, according to an example embodiment, a non-linear description may be employed to compute the input flow Qᵢₙ 266, that may serve as the input control value 116 of FIG. 1, as disclosed above, and the input flow Qᵢₙ 266, that is, Qᵢ(t), may be computed as:

$${Q}_{i} ( t ) = ( {C}_{1} + {C}_{2} ) \frac{d}{dt} \{ {Q}_{0}^{n} {R}_{2} + {Q}_{0}^{m} {R}_{3} \} + {R}_{1} {C}_{1} \frac{d}{dt} \{ {[ {C}_{2} \frac{d}{dt} \{ {Q}_{0}^{n} {R}_{2} + {Q}_{0}^{m} {R}_{3} \} + {Q}_{0} ]}^{p} \} + {Q}_{0} ( t )$$

In the above non-linear description, Q₀ is the target output flow 226 that may be any time-dependent output flow that is the desired (i.e., target) output flow. The parameters C₁ and C₂ are values of hydraulic capacitances of the extrusion mechanism and solid media, and the melted media and the wetted extruder geometry, respectively, such as values of the first hydraulic capacitance C1 260 and second hydraulic capacitance C2 262 of the hydraulic circuit model 205, disclosed above. The parameters n, m, p, and R₁, R₂, and R₃ contribute to a description of a pressure drop generated by a transport of the build material 214 through the extrusion assembly 206. The various R's may be referred to as hydraulic resistances, or just resistances, as disclosed above, where R₁, R₂, and R₃ correspond to values of the first resistance R1 244, second resistance R2 246, and third resistance R3 250, respectively, of the hydraulic circuit model 205.

The build material 214 may be approximated using a power-law rheological model. Using the power-law rheological model, the pressure drop in response to flow for each of three sections in the nozzle (a partially melted zone, a fully melted zone, and a region beyond the nozzle exit) may be given by:

Δpᵢ=Qᵢ^{x}Rᵢ

It should be understood that the partially melted zone may be a zone leading into the melting zone 218 in which the build material 214 is in a partially melted form. The fully melted zone may be a zone within the melting zone 218 in which the build material 214 is further melted, and the region beyond the nozzle exit, that is, beyond the nozzle tip 248, that may be just beyond an exit of the melting zone 218.

In the non-linear description disclosed above, the pressure drop is a non-linear function of the flow denoted with the exponent x. The pressure drop depends linearly upon the resistance Rᵢ (where i=1, 2, or 3), which contains attributes of the extruder geometry, such as lengths, radii, or any other suitable geometrical attribute, as well as material constants, such as a viscosity of the build material, or any other suitable material constant. The viscosity depends upon a temperature to which the build material 214 is subjected, along with an appropriate rheological description of the non-linear material. For the non-linear description disclosed above, a power-law description of the rheology may be employed:

n=k\dot{γ}ⁿ⁻¹

In this expression, both k (the consistency) and n (the power-law index) may vary with temperature. In practice, k may be much more temperature-dependent than n. The consistency may also be dependent upon a volume fraction of solids in the build material, although this may typically be held constant.

The hydraulic capacitances C₁ and C₂, disclosed above, may relate the amount of melted or partially melted build material 214 stored in the extrusion assembly 206 per an amount of pressure applied to the extrusion assembly, via:

$$C = \frac{dV}{dp} .$$

Such capacitances may depend on all properties of the extrusion assembly 206 and the build material 214 being extruded, in solid, semi-solid, and molten form. Properties upon which the capacitances depend may include, but are not limited to, an environmental temperature, rheological and mechanical characteristics of the extrusion material, a temperature of the extrusion material, a wetted geometry of the extrusion assembly, an actuation system of the extrusion assembly 206, as well as a geometry, orientation, or characteristics of the feedstock, that is, the build material 214 to be extruded.

As disclosed above, the hydraulic circuit model 205 may represent a non-linear or a linear description of the extrusion assembly 206 and the build material 214. A linear description is disclosed below with regard to the hydraulic circuit model 305 of FIG. 3.

FIG. 3 is a circuit diagram 300 of an another example embodiment of a hydraulic circuit model 305. The hydraulic circuit model 305 includes first, second, and third resistive elements, namely, Rₘᵤₛₕ 344, Rₘₑₗₜ 346, and R_{orf} 350, respectively, that correspond to the first resistance R1 244, second resistance R2 246, and third resistance R3 250, respectively, of FIG. 2, disclosed above. The hydraulic circuit model 305 further includes first and second capacitive elements, namely C_{rod} 360 and Cₘᵤₛₕ 362, respectively, that correspond to the first hydraulic capacitance C1 260 and second hydraulic capacitance C2 262, respectively, of FIG. 2, disclosed above. The first hydraulic capacitance C_{rod} 360 and the second hydraulic capacitance Cₘᵤₛₕ 362 are storage elements that may be inactive for constant flow of the build material through the extrusion assembly.

The hydraulic circuit model 305 may represent a linear or a non-linear description of the extrusion assembly 206 and the build material 214 of FIG. 2, disclosed above. An example embodiment of such a linear description may be:

$$\frac{{d}^{2} {Q}_{out}}{{dt}^{2}} + A \frac{{dQ}_{out}}{dt} + B ( {Q}_{out} - {Q}_{in} ) = 0$$

in which:

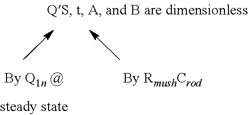

and

$$A = \frac{{R}_{melt}}{{R}_{mush}} [ 1 + \frac{{C}_{mush}}{{C}_{rod}} ( 1 + \frac{1}{\frac{{R}_{melt}}{{R}_{mush}} + \frac{{R}_{orf}}{{R}_{mush}}} ) ]$$

$$B = \frac{\frac{{R}_{melt}}{{R}_{mush}} \frac{{C}_{rod}}{{C}_{mush}}}{1 + \frac{{R}_{orf}}{{R}_{mush}}} .$$

Based on the above linear description, the input flow Qᵢₙ 366 of the build material 214 to achieve a target output flow Qₒᵤₜ 326 of the build material 214 may be determined by:

$${Q}_{in} = {Q}_{out} + \frac{A}{B} \frac{{dQ}_{out}}{dt} + \frac{1}{B} \frac{{d}^{2} {Q}_{out}}{{dt}^{2}}$$

An input control value, such as a value of the input flow Qᵢₙ 366, may be employed by a controller, such as the controller 112 of FIG. 1, disclosed above, to control at least one actuator, such as the at least one actuator 108 of FIG. 1 or the at least one actuator 208 of FIG. 2, such that the input flow of the build material is Qᵢₙ 366, enabling the target output flow Qₒᵤₜ 326 to be achieved, and obviating over- or under-extrusion of the build material 214 otherwise exhibited.

In the hydraulic circuit model 305, the first capacitive element C_{rod} 360 is coupled to a controlled volume generator 368, the first resistive element Rₘᵤₛₕ 344, and an ambient pressure 342. The second capacitive element Cₘᵤₛₕ 362 is coupled to the first resistive element Rₘᵤₛₕ 344 and the second resistive element Rₘₑₗₜ 346. The first resistive element Rₘᵤₛₕ 344 is coupled to the controlled volume generator 368, first capacitive element C_{rod} 360, second capacitive element Cₘᵤₛₕ 362, and the second resistive element Rₘₑₗₜ 346. The second resistive element Rₘₑₗₜ346 is coupled to the first resistive element Rₘᵤₛₕ 344, second capacitive element Cₘᵤₛₕ 362, and the third resistive element R_{orf} 350. The third resistive element R_{orf} 350 is coupled to the second resistive element Rₘₑₗₜ 346 and the ambient pressure 342. The ambient pressure 342 may be an atmospheric pressure.

The first capacitive element C_{rod} 360 may represent a first hydraulic capacitance of an extrusion assembly (not shown) and build material (not shown), in a solid form prior to an entrance of the melting zone 318. The second capacitive element Cₘᵤₛₕ 362 may represent a second hydraulic capacitance of the extrusion assembly and the build material within the melting zone 318. The first resistive element Rₘᵤₛₕ 344 may represent a first resistance of the build material in a melted or partially melted form within the melting zone 318. The second resistive element Rₘₑₗₜ 346 may represent a second resistance of the build material in the melted or partially melted form further within the melting zone 318 and closer to an exit of the melting zone 318 relative to the first resistance Rₘᵤₛₕ 344. The third resistive element R_{orf} 350 may represent a third resistance of the build material in the melted or partially melted form following exit from the melting zone 318.

The hydraulic circuit model 305 represents a description of an interaction of the build material in a solid, liquefied, or semi-solid form with a geometry of the extrusion assembly, such as the extrusion assemblies 106 and 206 of FIG. 1 and FIG. 2, respectively, as disclosed above, the interaction producing storage of the build material in the geometry as a function of imposed motion, imposed stress, or a combination thereof. Hydraulic capacitance values of the capacitive elements C_{rod} 360 and Cₘᵤₛₕ 362 may each represent a respective first amount of build material stored in the extrusion assembly per a second amount of pressure applied to the extrusion assembly at the one or more locations relative to the melting zone 318, such as the locations at a first node 336, second node 338, and third node 340 of the hydraulic circuit model 305. The resistive elements Rₘᵤₛₕ 344, Rₘₑₗₜ 346, and R_{orf} 350 may have respective resistance values that each represent a respective change in pressure per change in flow rate of build material (not shown) at the one or more locations relative to a melting zone 318, such as the locations at the first node 336, second node 338, and third node 340 of the hydraulic circuit model 305.

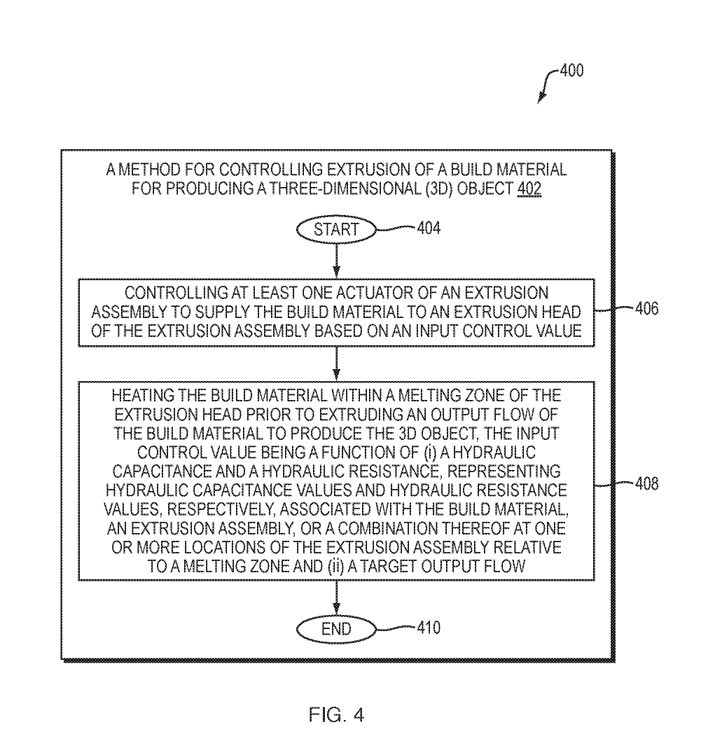

FIG. 4 is a flow diagram 400 of an example embodiment of a method for controlling extrusion of a build material for producing a three-dimensional (3D) object (402). The method begins (404) and controls at least one actuator of an extrusion assembly to supply the build material to an extrusion head of the extrusion assembly based on an input control value (406). The method heats the build material within a melting zone of the extrusion head prior to extruding an output flow of the build material to produce the 3D object, the input control value being a function of (i) a hydraulic capacitance and a hydraulic resistance, representing hydraulic capacitance values and hydraulic resistance values, respectively, associated with the build material, an extrusion assembly, or a combination thereof at one or more locations of the extruder assembly relative to a melting zone and (ii) a target output flow, the input control value enabling the output flow to match the target output flow (408) and the method thereafter ends (410), in the example embodiment.

Turning back to FIG. 2, the hydraulic circuit model 205 may represent a description of compliant interactions of mechanisms of the extrusion assembly 206 with the build material 214 in a solid, liquefied, or semi-solid form. The compliant interactions, such as deflection of the extrusion assembly 206, or any other suitable compliant interaction, may result in storage of the build material 214.

According to an example embodiment, a commanded setpoint, such as a commanded input pressure or commanded input flow of the build material 214 may take into account idiosyncrasies of the extruder assembly 206 and the build material 214. The commanded setpoint may be a revised commanded setpoint that adjusts for an error in the resultant output flow 220 due to such idiosyncrasies. Such idiosyncrasies may be accounted for via example embodiments of linear or non-linear hydraulic circuit models disclosed herein. According to an example embodiment, such hydraulic circuit models may be used with concurrent measurement of pressure (at any node in the hydraulic circuit diagram) or flow (at any node in the hydraulic circuit diagram).

For a case in which pressure and/or force measurements are made, the hydraulic circuit model may predict an amount of displacement with which to drive the at least one actuator 208 on the extrusion head 210. For a case in which flow is monitored, the hydraulic circuit model may predict a pressure (or force or torque or motor current based on a wetted geometry of the extrusion assembly 206) that may be needed in order to produce the target output flow 226. As a small error between the target output flow 226 and a resulting flow (i.e., the output flow Qₒᵤₜ 220), or small error between a desired pressure and a resulting pressure may result, an example embodiment may employ the hydraulic circuit model to achieve, e.g., 95% of the desired flow or desired pressure where a residual error, such as 5%, that is an error between the desired flow and resulting flow, or desired pressure and resulting pressure, may be neutralized by a controller, such as the controller 112 of FIG. 1, disclosed above. It should be understood that values of 95% and 5% are for example purposes and may be any suitable values.

Turning back to FIG. 1, the controller 112 may be further configured to receive a real-time measurement of the extrusion assembly 106 and adjust the input control value 116 based on the real-time measurement. The real-time measurement may include a flow measurement, pressure measurement, or printed line width measurement, or a combination thereof. Based on such a real-time measurement, the controller 112 may neutralize the residual error, as disclosed above.

According to an example embodiment, the controller 112 may be further configured to receive a commanded profile for extruding the build material 114 along a build surface, such as the build plate 256 of FIG. 2, disclosed above, and modify the commanded profile based on a hydraulic circuit model of the extrusion assembly 106, application of the hydraulic capacitance values 122 and the hydraulic resistance values 124 to the hydraulic circuit model, the target output flow 126, and real-time data and/or non-real time data of the extrusion assembly 106.

The real-time data may include at least one of: an ambient temperature of the extrusion assembly 106, a temperature of the build material 114 within the extrusion assembly 106, a first length of the build material 114 in solid form within the extrusion assembly 106, a second length of the build material 114 to be extruded from the extrusion assembly 106, or a diameter of the build material 114 to be extruded from the extrusion assembly 106. The non-real time data may include an extruder identifier of the extruder assembly 106 that identifies a type of the extruder assembly 106 or a build material identifier that identifies a type of the build material 114 or characteristic related thereto.

According to an example embodiment, fitted parameters, such as the hydraulic capacitance values 122 and the hydraulic resistance values 124, may be fit to a linear or non-linear model as a function of one or more parameters, such as the ambient temperature of the extrusion assembly 106, the temperature of the build material 114 within the extrusion assembly 106, the first length of the build material 114 in solid form within the extrusion assembly, the second length of the build material 114 to be extruded from the extrusion assembly 106, or the diameter of the build material 114 to be extruded from the extrusion assembly 106. The hydraulic capacitance values 122 and the hydraulic resistance values 124 may be determined based on same and may be stored in a memory and retrieved based on same via an association between the hydraulic capacitance values 122 and the hydraulic resistance values 124 and the one or more parameters.

For example, the hydraulic capacitance values 122 and the hydraulic resistance values 124 may be stored in a Look-Up Table (LUT) stored in a memory that may be indexed via a representation of the one or more parameters to retrieve hydraulic capacitance and resistance values determined based on same. As such, the controller 112 may access the hydraulic capacitance values 122 and the resistance values 124 based on the one or more parameters and apply the hydraulic capacitance values 122 and the resistance values 124 to a hydraulic circuit model, such as the hydraulic circuit models 205 and 305 of FIG. 2 and FIG. 3, disclosed above, along with the target output flow 126 in order to determine the input control value 116 that may be an input flow or pressure value for achieving a target output flow or pressure. It should be understood that the LUT is an example for providing a mechanism for storing and retrieving the hydraulic capacitance values 122 and the resistance values 124; however, such hydraulic capacitance and resistance values may be retrieved in any suitable manner based on the one or more parameters.

The one or more parameters may include non-real time and real-time parameters and may represent non-real time and real-time data. For example, the one or more parameters may include the non-real time data such as a characteristic of the build material, identifier of a specific extruder assembly, or any other suitable non-real time data, whereas the real-time data may include a temperature within the extrusion head, an ambient temperature of the extrusion assembly, or any other real-time data.

According to an example embodiment, the controller 112 may be further configured to receive at least one toolpath command for controlling movement of the extrusion assembly 106 along the build plate and to adjust the at least one toolpath command based on the input control value 116. For example, a computer-aided design (CAD) model of the 3D object 104 may be sliced by a slicer (not shown) and toolpath commands may be derived therefrom. The controller 112 may receive such toolpath commands and modify one or more of the toolpath commands based on applying the fitted parameters to the linear or non-linear models disclosed herein to determine the input control value 116 for achieving the target output flow 126 of the build material 114. It should be understood that the controller 112 may be a distributed controller and that the input control value 116 may be determined locally by the controller 112 or may be received from a remote controller (not shown).

Due to idiosyncrasies of the extrusion assembly 106 and build material 114, such as the capacitance of the build material 114, the extrusion assembly 106, or a combination thereof, over- or under-extrusion of the build material 106 may result unexpectedly in response to a toolpath command or a series thereof. A toolpath command may be any suitable command that results in motion of the extrusion assembly 106 relative to the 3D object 104 being printed, extrudate flow from the extrusion head 110, or a combination thereof. However, based on monitored real-time data of a three-dimensional (3D) printer and known non-real time characteristics of the build material 114 and extrusion assembly 106, fitted parameters, such as the hydraulic capacitance values 122 and the hydraulic resistance values 124 disclosed above, may be retrieved or computed and applied to a hydraulic circuit model, such as the hydraulic circuit models 205 and 305 of FIG. 2 and FIG. 3, respectively, with linear or non-linear descriptions, as disclosed herein. As such, the input control value 116 may be determined and the input control value 116 may be an input flow rate or input pressure, as disclosed above. Based on the input control value determined, the toolpath commands may be modified such that the target output flow 126 may be achieved, obviating the over- or under-extrusion that would otherwise result.

According to an example embodiment, the controller 112 may be a local controller. For example, the controller 112 may be co-located with the extrusion assembly 106. Alternatively, the controller 112 may be a remote controller that is remotely located relative to the extrusion assembly 106 and configured to receive real-time data, such as a length of the build material 114 prior to entering the extrusion head 110, a temperature within or ambient to the extrusion assembly 106, or any other suitable real-time data of the build material 114 or extrusion assembly 106, via a remote connection with the 3D printer including the extrusion assembly 106 in real or near-real time. The remote connection may be a wired or wire-less connection, or any other suitable connection for communicating the real-time data from the 3D printer including the extrusion assembly 106 to the local or remote controller 112.

Example embodiments disclosed below relate to determination of fitted parameters, such as the hydraulic capacitance values 122 and the hydraulic resistance values 124, employed by example embodiments of a hydraulic circuit model, such as the hydraulic circuit models 205 and 305 or FIG. 2 and FIG. 3, respectively.

Determination of the Parameters

As disclosed in the non-linear description disclosed above with reference to FIG. 2, there are 8 constants employed and such constants may be determined for each combination of build material 114 and type of extrusion assembly 106. These constants are the three power-law indices (m, n, q) and their corresponding hydraulic resistances (i.e., R₁, R₂, and R₃), and hydraulic capacitances (i.e., C₁ and C₂).

To determine values of such constants, two custom-built instruments were employed and results regarding same are disclosed. In a first device, termed mMFI, the efflux of mass and the pressure within the hot-end at a fixed set temperature and forcing condition were measured. That is, a fixed force was applied on the feedstock and extrusion was monitored while holding all other system parameters constant. Since the force applied to the feedstock was commanded, that is, known, and varied, and since the pressure within the melt was measured, a pressure required to extrude at various rates of flow out of the nozzle tip may be determined. In this way, m, n, R₁, and R₂ may be determined. Such terms may be determined under constant forcing such that all pressure and extrusion rate measurements may be made at steady-state.

Utilizing a second custom-built instrument, the terms p, R₃, C₁, C₂ were determined. On this second custom-built instrument, the displacement of the feedstock was commanded and a cross-section of a printed line along with a pressure within the melting zone (at the same location as on the mMFI instrument) was measured. To determine p and R₃, the nozzle was configured to be at a desired height from the bed. Then, a fixed rate of displacement was applied to the feedstock and the pressure required to actuate the flow was measured. This resistance may also be a function of the bed speed, although bed speed may be ignored as this effect in the hydraulic circuit model is anticipated to have an effect that has a small contribution to the overall resistance of the build material through the hot-end.

Now that the terms p, m, n, R₁, R₂, and R₃ have been determined, the hydraulic capacitances C₁ and C₂ may be characterized utilizing the hydraulic circuit model. Since the hydraulic capacitances relate an amount of volume stored per change in pressure over time, a transient test was employed. In this transient test, a line may be printed such that a width of the printed line is varied at some point along the printed line. This could include a step change, ramp, sinusoid, or any shape resulting from a variation of the flow along the toolpath for the printed line. A step change may be useful as it may be simplest to resolve. Once the line is printed with a varying feature, a width of the line may be characterized as a function of position using a suitable sensor. Since both the measured line output and the commanded line input may be commanded as a function of time, a prediction of the line output may be obtained from the hydraulic circuit model for any values of C₁ and C₂, and a minimization may be performed to determine the values of C₁ and C₂ which best predict an observed profile given an input command. The penalty function for this optimization may be a normalized error between a line width profile predicted by the hydraulic circuit model and a line width observed in such an experiment.

Following determination of the terms p, m, n, R₁, R₂, and R₃, the hydraulic circuit model may be deployed on a 3D printer to account for interactions between the extrusion assembly mechanics and properties of the feedstock employed.

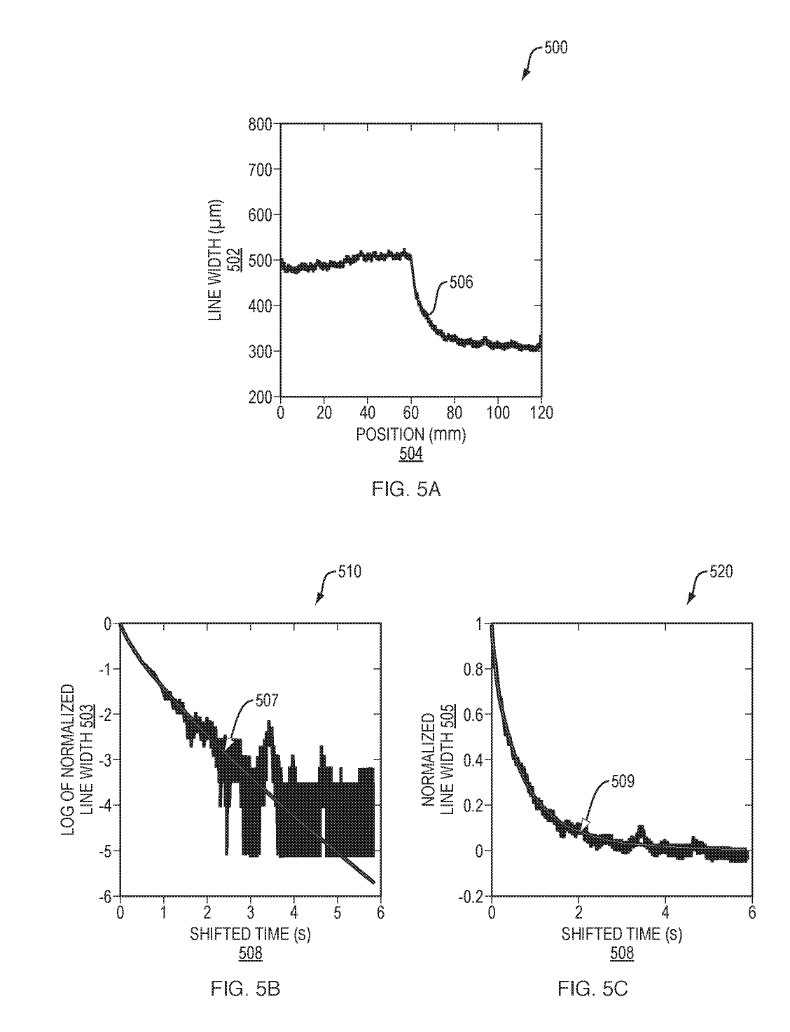

FIG. 5A is a graph 500 of an example embodiment of over-extrusion. As disclosed above, due to idiosyncrasies of the extrusion assembly and build material, such as the capacitance of a build material, extrusion assembly, or a combination thereof, over- or under-extrusion of the build material may result unexpectedly in response to a toolpath command or a series thereof. The graph 500 includes a plot 506 of measured line width 502 of extrudate of build material produced at a position 504 along a build plate in response to a commanded variation of input flow resulting in a commanded variation of output flow. The plot 506 illustrates a response to a change in commanded flow associated with step change from 500 μm to 300 μm in line width. Instead of measuring a sharp change in the line width 502 from 500 μm to 300 μm, the plot 506 illustrates a gradual change from 500 μm to 300 μm, due to over-extrusion.

FIG. 5B is a graph 510 of log values of normalized line widths 503 of the line widths 502 of the graph 500 of FIG. 5A over time 508. The graph 510 illustrates exponential decay 507 due to over-extrusion instead of a straight line.

FIG. 5C is a graph 520 of normalized line widths 505 of the line widths 502 of the graph 500 of FIG. 5A over time 508. The graph 520 includes a fitted curve 509 that may be used to determine, via integration, the amount that is over extruded.

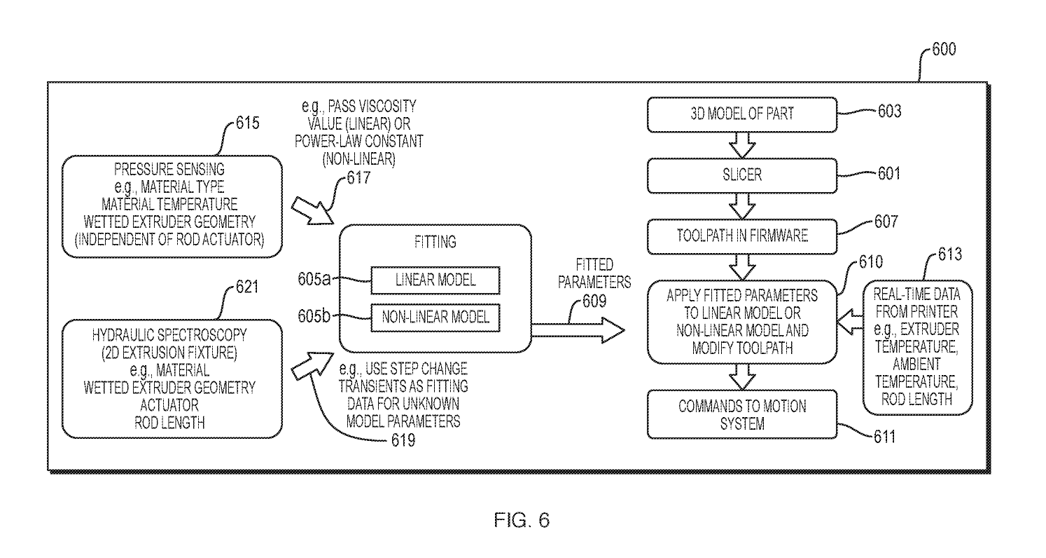

FIG. 6 is a block diagram of an example embodiment of a control system 600 for a three-dimensional (3D) printing system (not shown). The control system 600 may include a slicer 601 that is configured to slice a 3D CAD model 603 of a 3D object into two-dimensional slices that may be used to generate a toolpath in firmware 607 for extruding the build material to fabricate the 3D object. The control system 600 may employ a linear model 605a or non-linear model 605b and may be configured to apply 610 fitted parameters 609 to the linear model 605a or non-linear model 605b and use real-time data 613 from the 3D printing system to modify the toolpath in firmware 607 and generate 611 commands to a motion system based on same. The real-time data 613 may include any suitable real-time data of the 3D printing system and may include, for example, a temperature of the extrusion assembly, an ambient temperature, a length of the build material, etc. The motion system may control an extrusion assembly of the 3D printing system to fabricate the 3D object based on the commands to the motion system.

The fitted parameters 609 may be generated, as disclosed above, based on pressure sensing information 617 that may include a viscosity value employed by the linear model 605a or a power-law constant employed by the non-linear model 605b. The pressure sensing information 617 may be generated by a pressure sensing unit 615 that includes pressure sensors and may be configured to derive the pressure sensing information 617 based on measurements of the pressure sensors and extruder information, such as material type of the build material, temperature of the build material, and a wetted geometry of the extrusion assembly that excludes the actuator. The fitted parameters 609 may be further based on step change transient information 619 collected from an extrusion fixture 621.

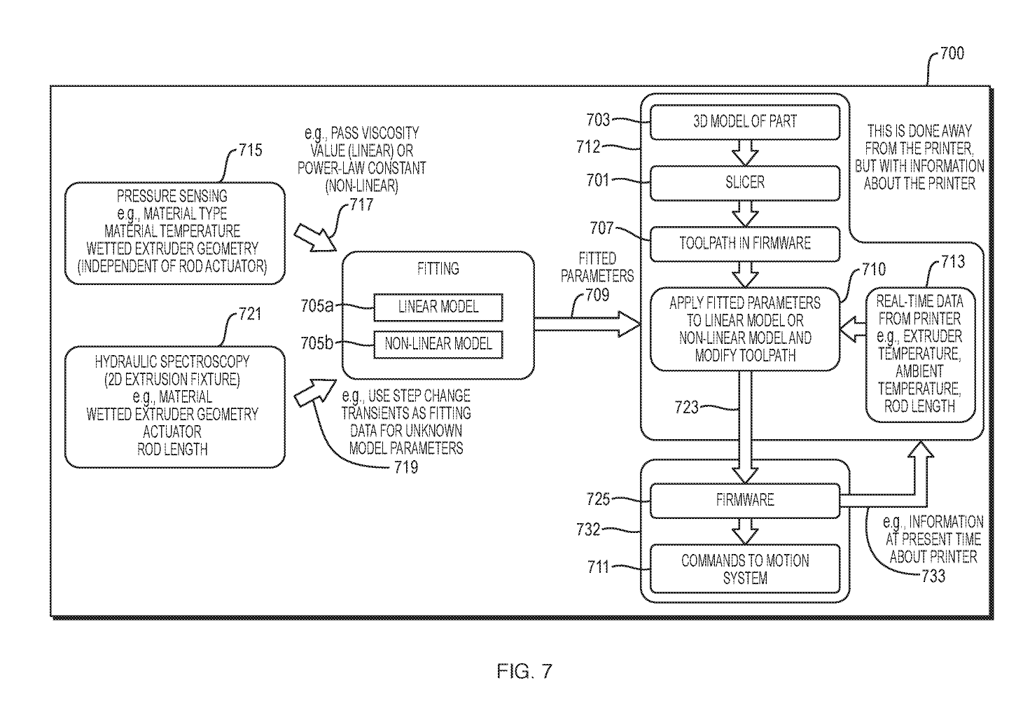

FIG. 7 is a block diagram of another example embodiment of a control system 700 for a 3D printing system (not shown). In the example embodiment of FIG. 7, portions of the control system 700 are performed by a remote controller 712 and by a local controller 732. The remote controller 712 is not co-located with the 3D printing system and drives control signals, such as the control signal(s) 128 of FIG. 1, indirectly, via the local controller 732. The remote controller 732 is communicatively coupled to the local controller 732 via an suitable communication path that may be a wired or wireless communication path. The local controller 732 may communicate information 733 about the 3D printing system that may be real-time data. The information 733 may include any suitable real-time data of the 3D printing system and may include, for example, a temperature of the extrusion assembly, an ambient temperature, a length of the build material, etc.

The remote controller 712 may include a slicer 701 that is configured to slice a 3D CAD model 703 of a 3D object (not shown) into two-dimensional slices that may be used to generate a toolpath in firmware 707 for extruding the build material to fabricate the 3D object. The remote controller 312 may employ a linear model 705a or non-linear model 705b and may be configured to apply 710 fitted parameters 709 to the linear model 705a or non-linear model 705b and use real-time data 713 that includes the information 733 received from the 3D printing system to modify the toolpath in firmware 707 and send the modified toolpath information 723 to the local controller 732.

The local controller 732 may include firmware 725 that may interpret the modified toolpath information 723 and generate 711 commands to a motion system based on same. The motion system may control an extrusion assembly of the 3D printing system to fabricate the 3D object based on the commands to the motion system.

The fitted parameters 709 may be generated, as disclosed above, based on pressure sensing information 717 that may include a viscosity value employed by the linear model 705a or a power-law constant employed by the non-linear model 705b. The pressure sensing information 717 may be generated by a pressure sensing unit 715 that includes pressure sensors and may be configured to derive the pressure sensing information 717 based on measurements of the pressure sensors and extruder information, such as material type of the build material, temperature of the build material, and a wetted geometry of the extrusion assembly that excludes the actuator. The fitted parameters 709 may be further based on step change transient information 719 collected from an extrusion fixture 721.

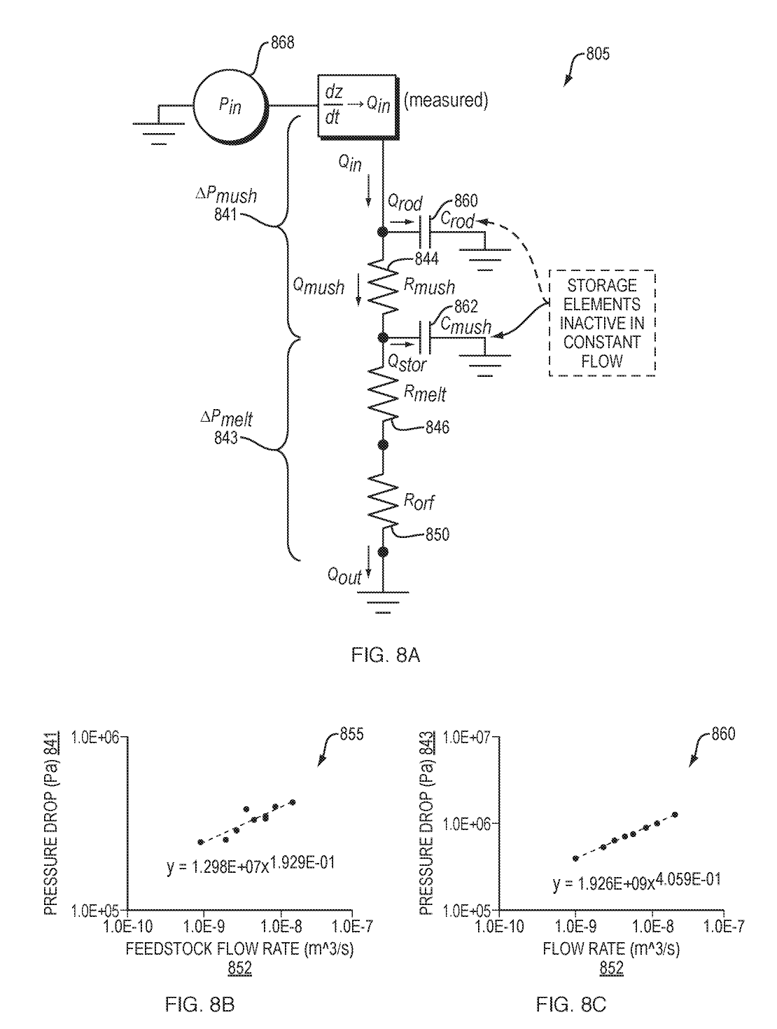

FIG. 8A is circuit diagram of an example embodiment of a non-linear model 805. A pressure sensing unit (not shown), such as the pressure sensing units 615 and 715 of FIG. 6 and FIG. 7, respectively, may employ the non-linear model 805 to determine the pressure sensing information 717 that may include a viscosity value employed by the linear model 705a or a power-law constant employed by the non-linear model 705b.

As disclosed above, the build material may be approximated using a power-law rheological model. Using the power-law rheological model, the pressure drop in response to flow for each of three sections in the nozzle (a partially melted zone, a fully melted zone, and a region beyond the nozzle exit) may be given by:

ΔP=RQⁿ

In the example embodiment of FIG. 8, pressure sensing maybe based on interrogating the pressure under a force-controlled experiment and the build material may be heated to a suitable temperature, such as 190C. An example embodiment of such a forced controlled experiment was performed to sense a first pressure drop ΔPₘᵤₛₕ 841 across Rₘᵤₛₕ 344 and a second pressure drop ΔPₘₑₗₜ 843 across Rₘₑₗₜ 346, and R_{orf} 350. In the forced controlled experiment, a controlled pressure generator 868 was configured to apply constant pressure to the feedstock. As such, the storage elements C_{rod} 860 and Cₘᵤₛₕ 862 were inactive due to constant flow of the feedstock. Results from such a forced controlled experiment are illustrated in FIG. 8B and FIG. 8C, disclosed below.

FIG. 8B is a graph 855 of an example embodiment of the first pressure drop 841 of FIG. 8A based on feedstock flow rate Q 852. Data from the graph 855 yields the following relationship for the first pressure drop ΔPₘᵤₛₕ 841:

ΔPₘᵤₛₕ=1.298×10⁷Q^{0.192}.

As such, Rₘᵤₛₕ 844 was determined to be 1.298, in the example embodiment.

FIG. 8C is a graph 860 of an example embodiment of the second pressure drop 843 of FIG. 8A based on feedstock flow rate Q 852. Data from the graph 860 yields the following relationship for the second pressure drop ΔPₘₑₗₜ 843:

ΔPₘₑₗₜ=1.926×10⁹Q^{0.406}.

As such, Rₘₑₗₜ 846 in combination with R_{orf} 850 was determined to be 1.926, in the example embodiment.

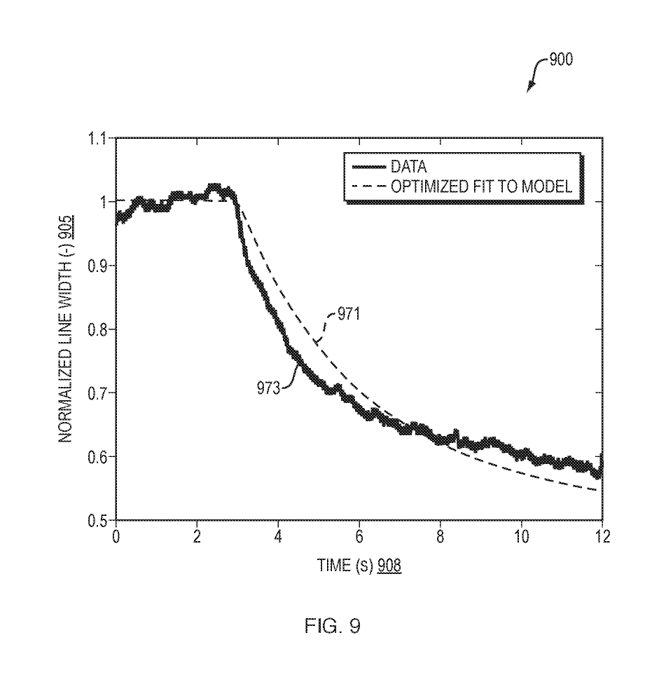

FIG. 9 is a graph 900 of an example embodiment of normalized line widths 905 over time 908. The graph 900 includes a plot 971 of normalized line widths of extrudate with fit from a non-linear model 805 of FIG. 8A, disclosed above and another plot 973 of normalized line widths of extrudate without fit from the non-linear model. As disclosed above with regard to FIGS. 8B and 8C, resistance of the non-linear model 805 were measured from a pressure sensor. Capacitances of the non-linear model 805 were determined by measuring a response of the extruder assembly and build material to a step change in line width. The step change was fitted with the non-linear model 805 to determine the capacitances. Such measured and fitted parameters were used with the non-linear model 805 to compute modified profiles to the extrusion assembly employed to extrude the extrudate which was measured to generate the plot 971.

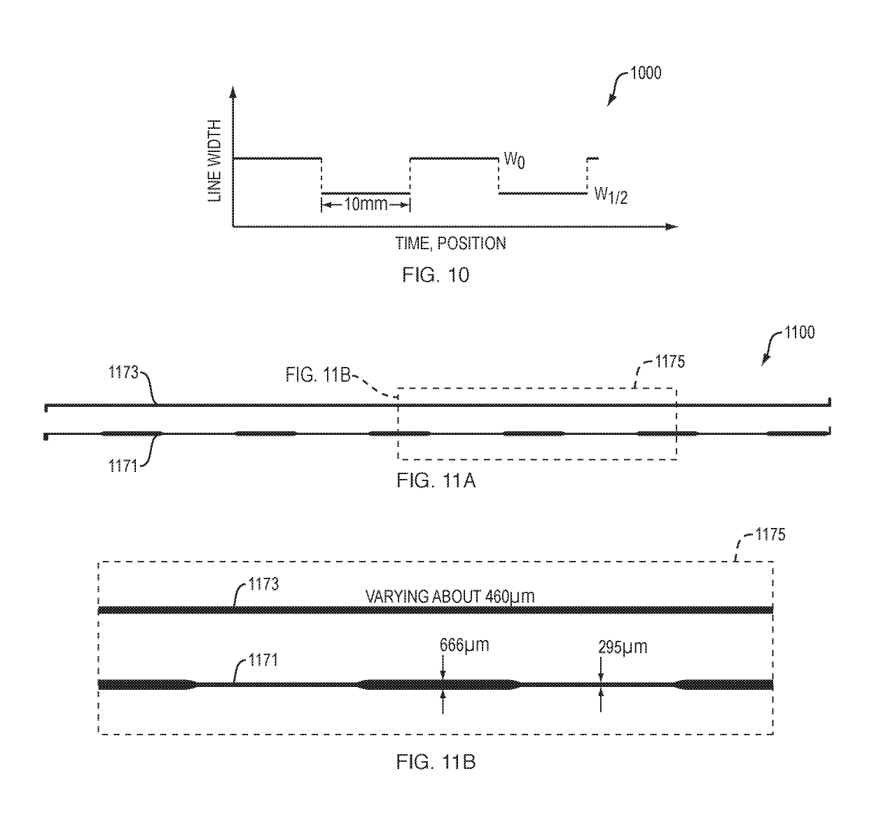

FIG. 10 is a graph 1000 of an example embodiment of commanded step changes in line width that may be used to generate print lines of extrudate with rapidly varying width. Such commanded step changes may be used to determine capacitances of a model, as disclosed above.

FIG. 11A is a plot of an example embodiment of printed geometry 1100 in response to the commanded step changes of FIG. 10, disclosed above. The printed geometry 1100 includes a first printed line 1173 that is based on an open loop method that does not modify the extrusion profile based on a model. The printed geometry 1100 includes a second printed line 1171 that is based on a control method that modifies the extrusion profile based on a model, such as the non-linear model 805 of FIG. 8A, disclosed above. As illustrated in the example embodiment, the first printed line 1173 does not produce any discernible variation in the printed geometry due to over-extrusion whereas the second printed line 1171 produces a discernible variation. A section 1175 is magnified and illustrated in FIG. 11B, disclosed below.

FIG. 11B is a magnified view of the section 1175 of the printed geometry 1100 of FIG. 11A, disclosed above. By employing example embodiments disclosed herein, deviation between commanded line width and observed line width may be minimized. As illustrated the magnified view, the second printed line 1171 has discernible variation based on commanded line width whereas the first printed line 1173 does not.

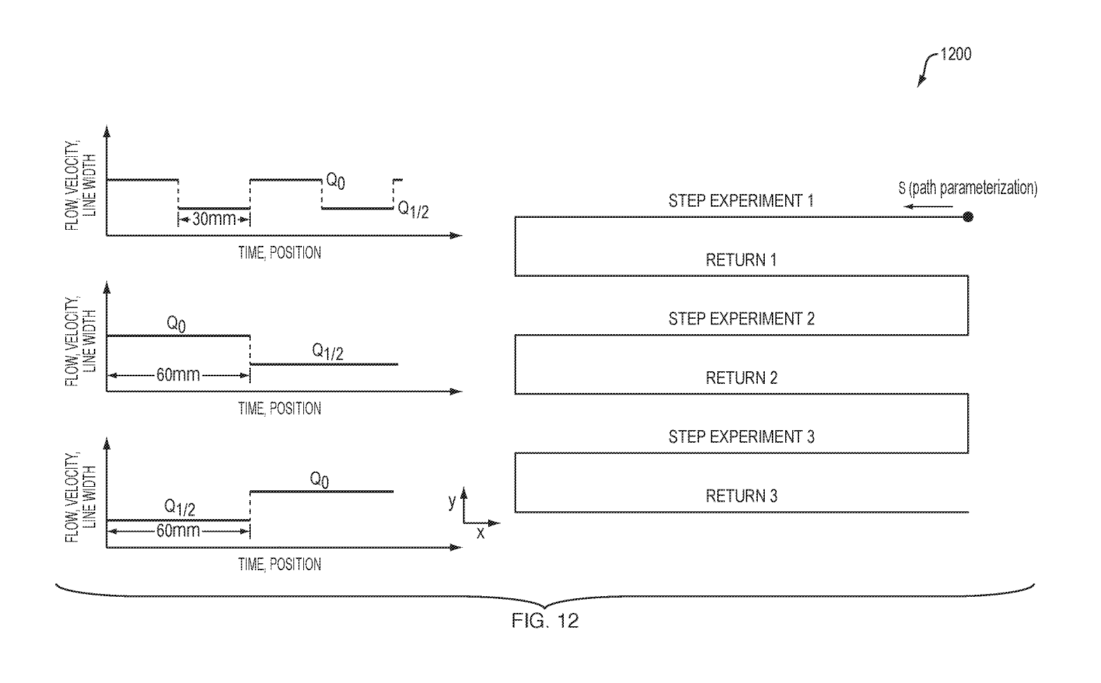

FIG. 12 is a graph 1200 of an example embodiment commanded profiles that may be employed to determine parameters of a hydraulic circuit model, as disclosed above. Such commanded profiles may be repeated multiple times, for example, 4×@ 10, 20, 30, and 40 mms/s stage speed.

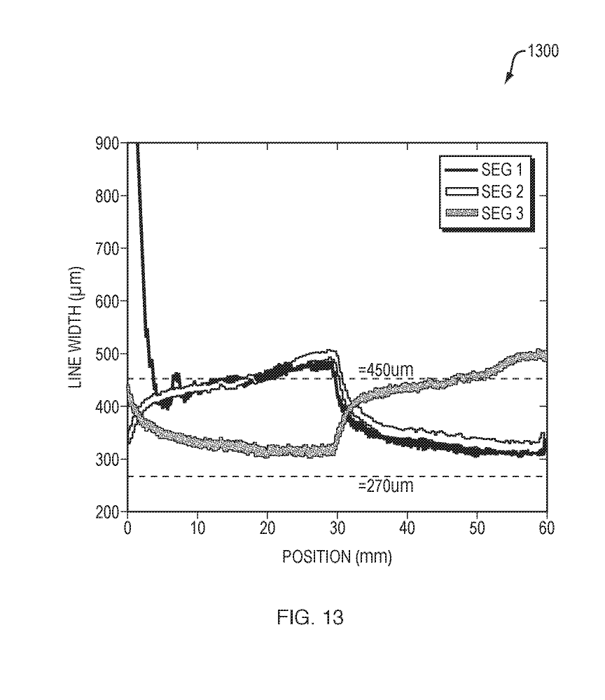

FIG. 13 is a graph 1300 of an example embodiment of line widths for three segments of extrudate. Data of the graph 1300 was obtained by stepping up/down a flow command for a 3 mm feedstock. Data of the graph illustrates tracking line width as a function of position. The graph 1300 illustrates slow convergence to target line width and responses that appear to behave, initially, as a resistor-capacitor (RC) circuit.

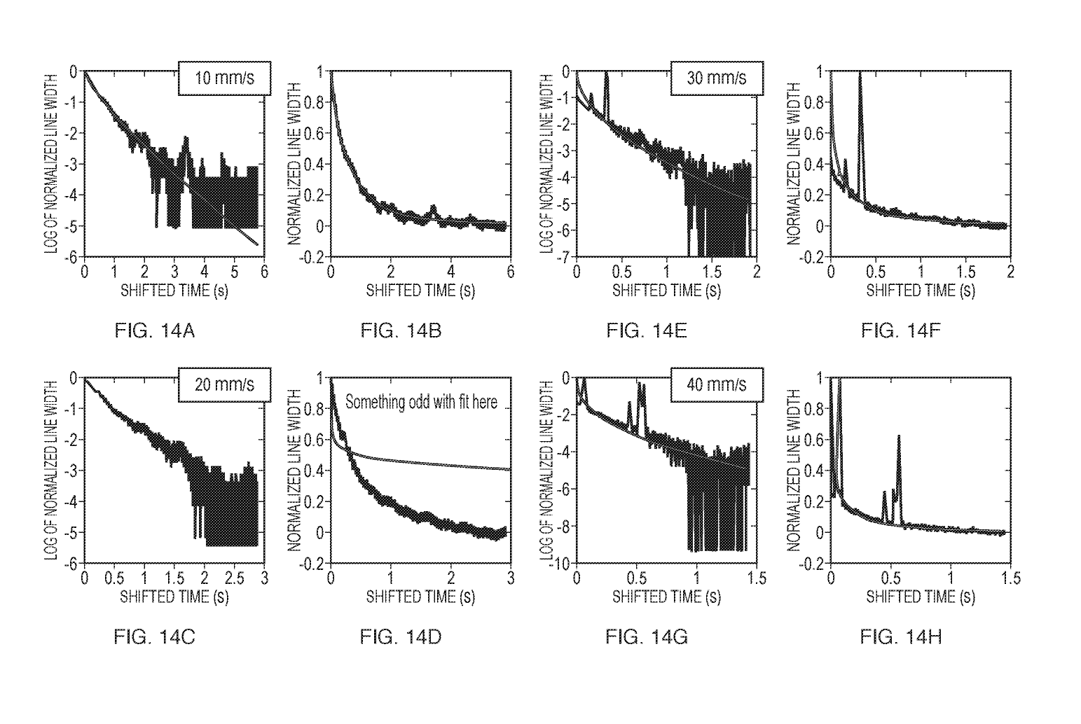

FIG. 14A is a graph of an example embodiment of log of normalized line width over time for a stage speed of 10 mm/s.

FIG. 14B is a graph of an example embodiment of normalized line width over time for the stage speed of 10 mm/s.

FIG. 14C is a graph of an example embodiment of log of normalized line width over time for a stage speed of 20 mm/s.

FIG. 14D is a graph of an example embodiment of normalized line width over time for the stage speed of 20 mm/s.

FIG. 14E is a graph of an example embodiment of log of normalized line width over time for a stage speed of 30 mm/s.

FIG. 14F is a graph of an example embodiment of normalized line width over time for the stage speed of 30 mm/s.

FIG. 14G is a graph of an example embodiment of log of normalized line width over time for a stage speed of 40 mm/s.

FIG. 14H is a graph of an example embodiment of normalized line width over time for the stage speed of 40 mm/s.

As illustrated by FIGS. 14A-H, a shape of the curves appears invariant to the stage speed.

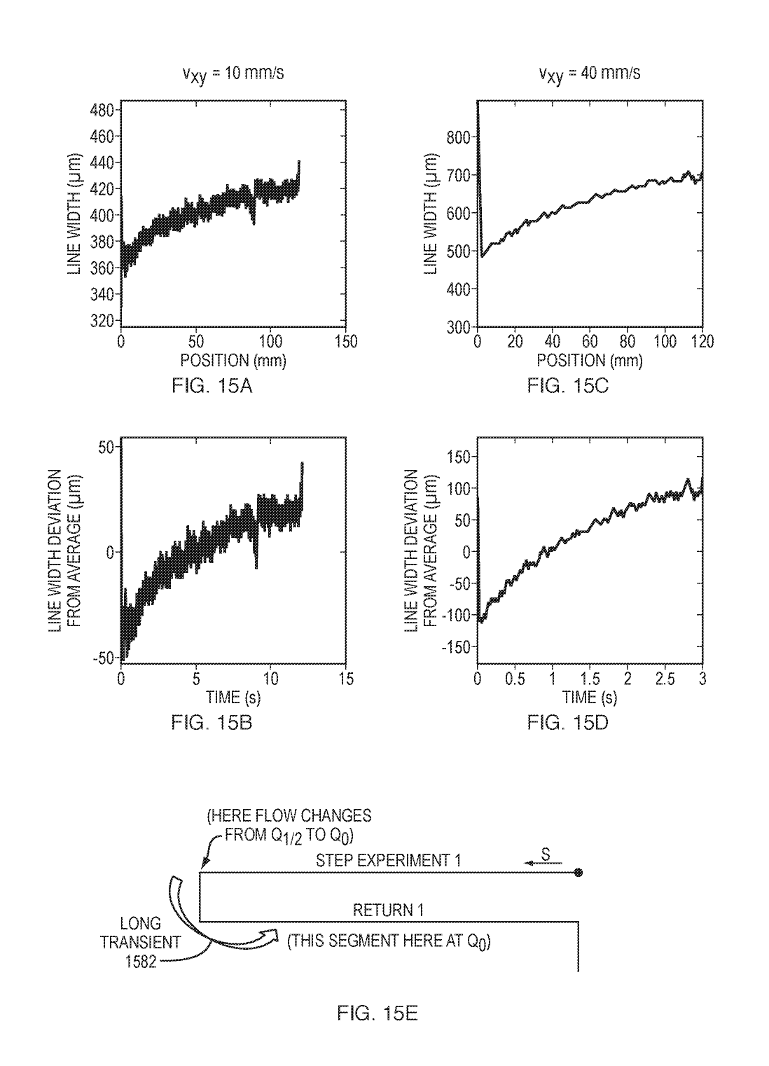

FIG. 15A is a graph of an example embodiment of line width relative to position on a stage for a stage speed of 10 mm/s.

FIG. 15B is a graph of an example embodiment of line width deviation from an average over time for the stage speed of 10 mm/s.

FIG. 15C is a graph of an example embodiment of line width relative to position on a stage for a stage speed of 40 mm/s.

FIG. 15D is a graph of an example embodiment of line width deviation from an average over time for the stage speed of 40 mm/s.

As illustrated in FIGS. 15A-D, line widths at Q₀ are due to storage of the media above the hotend and noise decreases with increase in extrusion and stage speed. A long transient clouds measurement of an equilibrium line width.

FIG. 15E is block diagram illustrating an example embodiment of the long transient 1582.

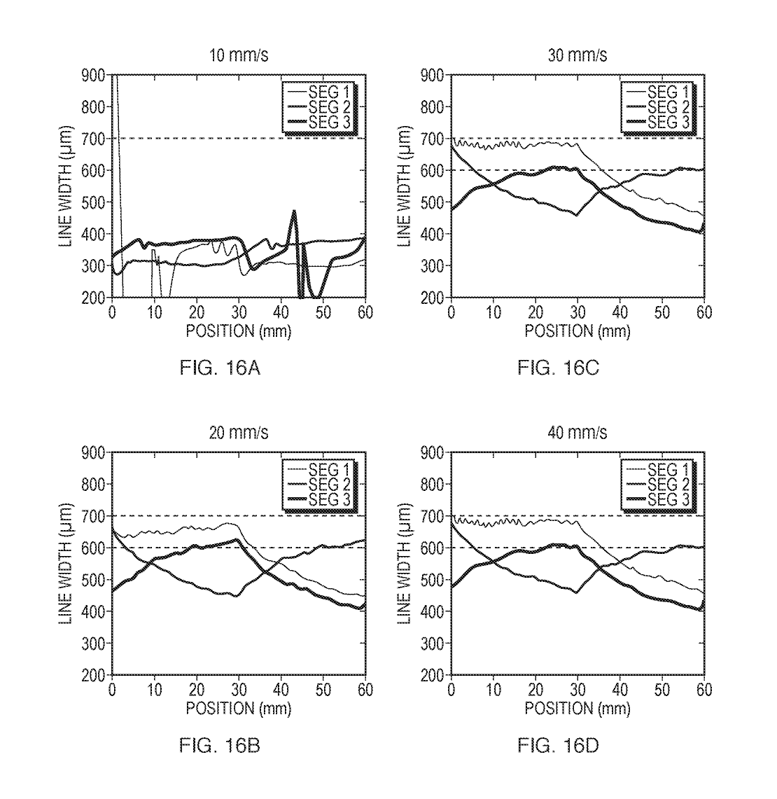

FIG. 16A is a graph of an example embodiment of line width of extrudate relative to a position on a stage with a speed of 10 mm/s.

FIG. 16B is a graph of an example embodiment of line width of extrudate relative to a position on a stage with a speed of 20 mm/s.

FIG. 16C is a graph of an example embodiment of line width of extrudate relative to a position on a stage with a speed of 30 mm/s.

FIG. 16D is a graph of an example embodiment of line width of extrudate relative to a position on a stage with a speed of 40 mm/s.

As illustrated in FIGS. 16A-D, the average high width of Seg 1 is fairly consistent. The height achieved in Seg 2 is inconsistent with the Seg 1 value, suggesting a long transient. Except for the 10 mm/s stage speed traces of FIG. 16A, the hotend is primed a the high flow before the first step (i.e., Seg 1).

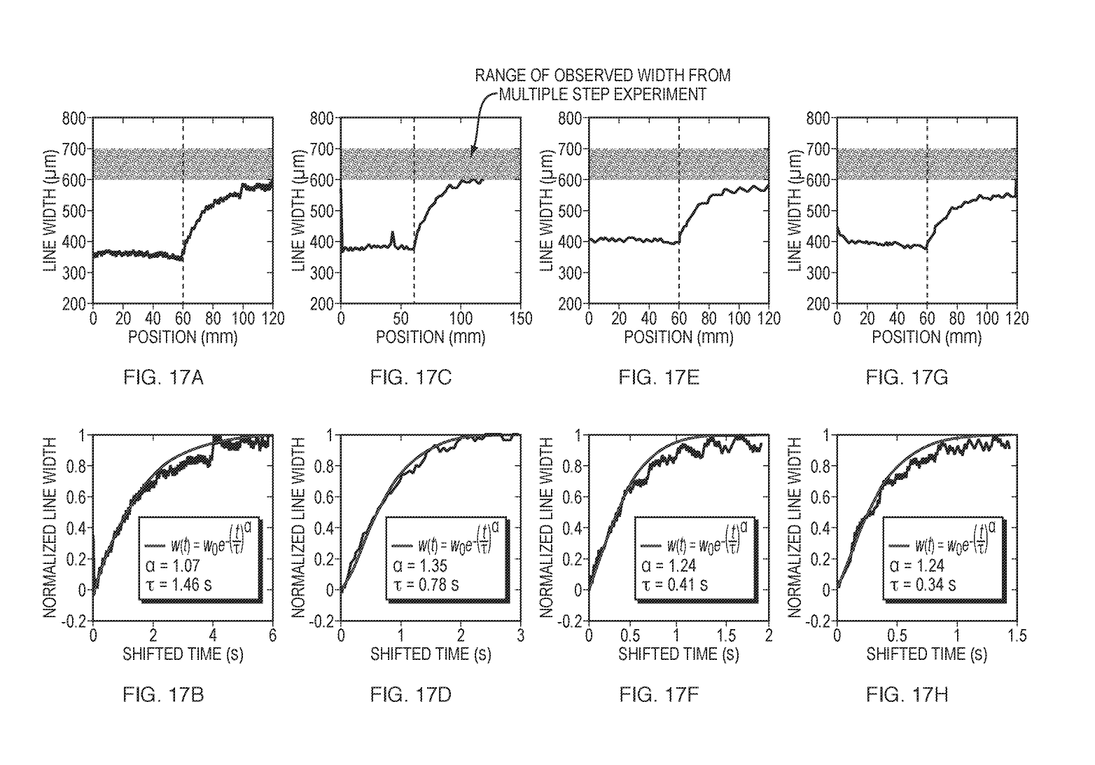

FIG. 17A is graph of an example embodiment of line width of extrudate at a position on a stage.

FIG. 17B is a graph of an example embodiment of normalized line width of FIG. 17A over time.

FIG. 17C is graph of another example embodiment of line width of extrudate at a position on a stage.

FIG. 17D is a graph of an example embodiment of normalized line width of FIG. 17C over time.

FIG. 17E is graph of another example embodiment of line width of extrudate at a position on a stage.

FIG. 17F is a graph of an example embodiment of normalized line width of FIG. 17E over time.

FIG. 17G is graph of another example embodiment of line width of extrudate at a position on a stage.

FIG. 17H is a graph of an example embodiment of normalized line width of FIG. 17G over time.

As illustrated by the graphs of FIGS. 17A-H, a range of observed widths resulted from a multiple step experiment.

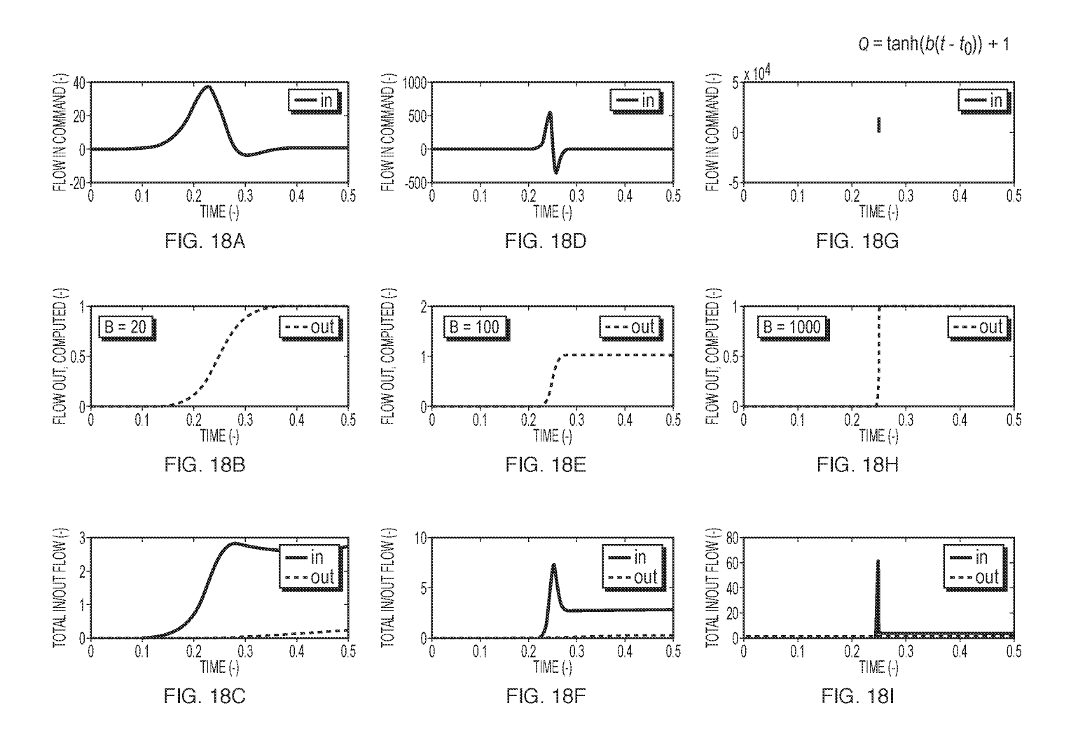

FIG. 18A is a graph of an example embodiment of a flow in command over time.

FIG. 18B is a graph of an example embodiment of flow out, computed, over time.

FIG. 18C is a graph of an example embodiment of total in/out flow over time.

FIG. 18D is a graph of another example embodiment of a flow in command over time.

FIG. 18E is a graph of another example embodiment of flow out, computed, over time.

FIG. 18F is a graph of another example embodiment of total in/out flow over time.

FIG. 18G is a graph of another example embodiment of a flow in command over time.

FIG. 18H is a graph of another example embodiment of flow out, computed, over time.

FIG. 18I is a graph of another example embodiment of total in/out flow over time.

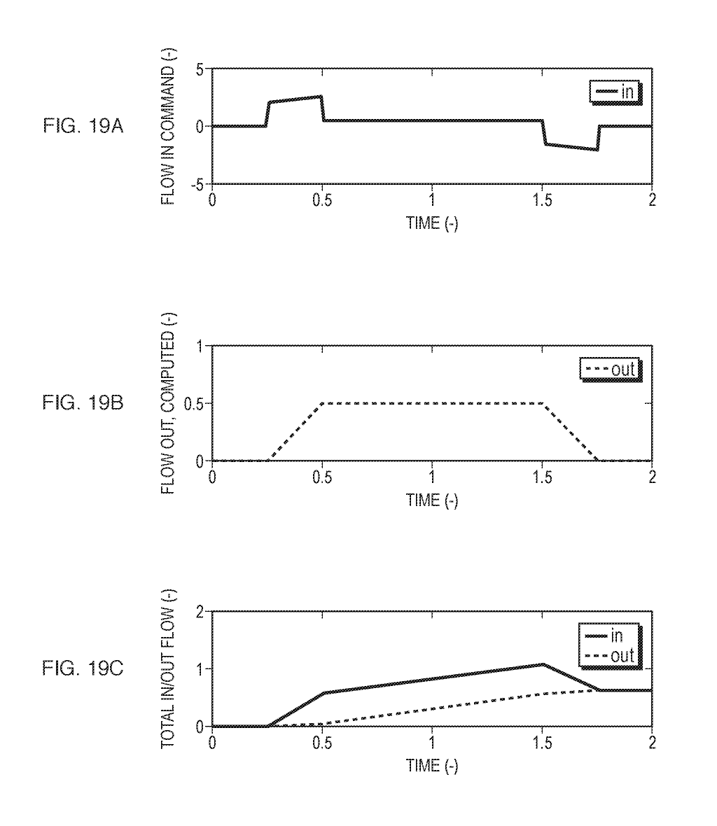

In the example embodiments of FIGS. 18A-I, an input function for the flow in command is a step function. However, any suitable function may be applied. For example, just a few neighboring input commands in time may be applied, such as five, ten, or fifteen. FIGS. 19A-C, disclosed below, employ a ramp function.

FIG. 19A is a graph of yet another example embodiment of a flow in command over time.

FIG. 19B is a graph of yet another example embodiment of flow out, computed, over time.

FIG. 19C is a graph of yet another example embodiment of total in/out flow over time.

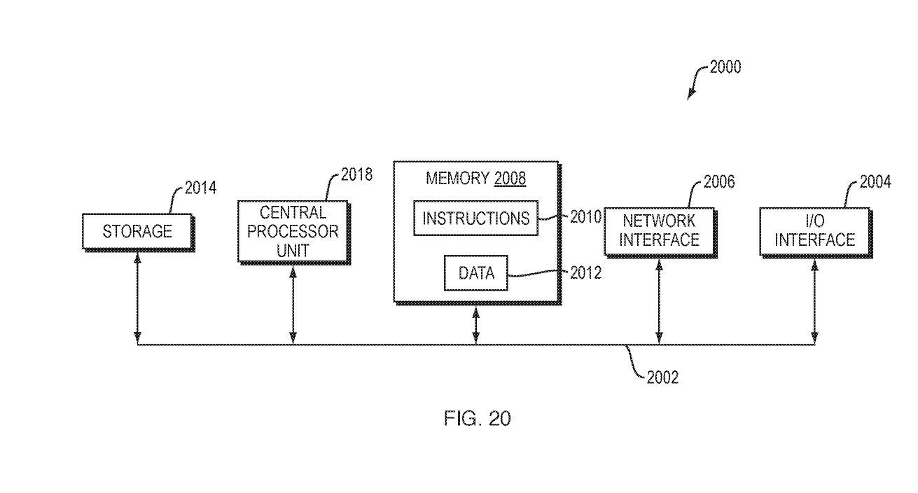

FIG. 20 is a block diagram of an example of the internal structure of a computer 2000 in which various embodiments of the present disclosure may be implemented. The computer 2000 contains a system bus 2002, where a bus is a set of hardware lines used for data transfer among the components of a computer or processing system. The system bus 2002 is essentially a shared conduit that connects different elements of a computer system (e.g., processor, disk storage, memory, input/output ports, network ports, etc.) that enables the transfer of information between the elements. Coupled to the system bus 2002 is an I/O device interface 2004 for connecting various input and output devices (e.g., keyboard, mouse, displays, printers, speakers, etc.) to the computer 2000. A network interface 2006 allows the computer 2000 to connect to various other devices attached to a network. Memory 2008 provides volatile or non-volatile storage for computer software instructions 2010 and data 2012 that may be used to implement embodiments of the present disclosure, where the volatile and non-volatile memories are examples of non-transitory media. Disk storage 2014 provides non-volatile storage for computer software instructions 2010 and data 2012 that may be used to implement embodiments of the present disclosure. A central processor unit 2018 is also coupled to the system bus 2002 and provides for the execution of computer instructions.

Further example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A system for producing a three-dimensional (3D) object, the system comprising:
an extrusion assembly including at least one actuator and an extrusion head; and
a controller, the controller configured to control the at least one actuator to supply a build material to the extrusion head based on an input control value, the extrusion head configured to heat the build material within a melting zone of the extrusion head prior to extruding an output flow of the build material to produce the 3D object, the input control value being a function of (i) a hydraulic capacitance and a hydraulic resistance, representing hydraulic capacitance values and hydraulic resistance values, respectively, associated with the build material, the extrusion assembly, or a combination thereof at one or more locations of the extrusion assembly relative to the melting zone and (ii) a target output flow, the input control value enabling the output flow to match the target output flow.

2. The system of claim 1, wherein the melting zone is a region of the extrusion assembly within which the build material is deformed, irreversibly, due to an increase in temperature.

3. The system of claim 1, wherein the input control value is an input flow value or an input pressure value.

4. The system of claim 1, wherein the hydraulic resistance values each represent a respective change in pressure per change in flow rate of the build material at the one or more locations relative to the melting zone.

5. The system of claim 1, wherein the hydraulic capacitance values each represent a respective first amount of build material stored in the extrusion assembly per a second amount of pressure applied to the extrusion assembly at the one or more locations relative to the melting zone.

6. The system of claim 1, wherein the hydraulic capacitance values include a first hydraulic capacitance value and a second hydraulic capacitance value, the first hydraulic capacitance value representing a first hydraulic capacitance of the extrusion assembly and the build material in a solid form prior to an entrance of the melting zone, the second hydraulic capacitance value representing a second hydraulic capacitance of the extrusion assembly and the build material in a melted or partially melted form within the melting zone.

7. The system of claim 1, wherein the hydraulic resistance values include a first resistance value, a second resistance value, and a third resistance value, the first resistance value representing a first resistance of the build material in a first melted or partially melted form within the melting zone, the second resistance value representing a second resistance of the build material in a second melted or partially melted form further within the melting zone and closer to an exit of the melting zone relative to the first resistance, the third resistance value representing a third resistance of the build material in a third melted or partially melted form following the exit of the melting zone and outside of the extrusion head.

8. The system of claim 1, wherein the hydraulic capacitance values and hydraulic resistance values are specific to at least one of: the extrusion assembly, a wetted geometry of the extrusion assembly, a characteristic of the build material, an ambient temperature surrounding and external to the extrusion assembly, a temperature of the build material within the extrusion assembly, a length of the build material in a solid form between the at least one actuator and the melting zone to be extruded from the extrusion assembly, or a diameter of the build material to be extruded from the extrusion assembly.

9. The system of claim 1, wherein the hydraulic capacitance values and the hydraulic resistance values are associated with capacitive and resistive elements, respectively, in a hydraulic circuit model.

10. The system of claim 1, wherein the hydraulic resistance values are determined based on measuring an efflux of mass or volume of the build material and a pressure within the extrusion assembly at a fixed set temperature and forcing condition applied to the build material.

11. The system of claim 1, wherein the hydraulic resistance values are determined based on measuring a pressure within the extrusion assembly at a fixed set temperature and constant rates of influx of mass or volume of the build material.

12. The system of claim 1, wherein the hydraulic capacitance values are determined based on a measured line width of the build material produced along a build plate in response to a commanded variation of the output flow.

13. The system of claim 1, wherein the hydraulic capacitance values are determined prior to, during, or after printing of the 3D object.

14. The system of claim 1, wherein the hydraulic resistance values are determined prior to, during, or after printing of the 3D object.

15. The system of claim 1, wherein the extrusion head is configured to heat the build material within the melting zone via at least one heating element coupled to the extrusion head or via friction.

16. The system of claim 1, wherein the controller is further configured to receive a real-time measurement of the extrusion assembly and adjust the input control value based on the real-time measurement, the real-time measurement including a flow measurement, pressure measurement, printed line width measurement, or a combination thereof.

17. The system of claim 1, wherein the controller is further configured to receive a commanded profile for extruding the build material along a build surface and to modify the commanded profile based on a hydraulic circuit model of the extrusion assembly, application of the hydraulic capacitance values, the hydraulic resistance values, and the target output flow to the hydraulic circuit model, and real-time data of the extrusion assembly.

18. The system of claim 1, wherein the controller is further configured to receive at least one toolpath command for controlling movement of the extrusion assembly along the build plate and to adjust the at least one toolpath command based on the input control value.

19. The system of claim 1, wherein the controller is a local controller.

20. The system of claim 1, wherein the controller is a remote controller.

21. A method for controlling extrusion of a build material for producing a three-dimensional (3D) object, the method comprising:
controlling at least one actuator of an extrusion assembly to supply the build material to an extrusion head of the extrusion assembly based on an input control value; and
heating the build material within a melting zone of the extrusion head prior to extruding an output flow of the build material to produce the 3D object, the input control value being a function of (i) a hydraulic capacitance and a hydraulic resistance, representing hydraulic capacitance values and hydraulic resistance values, respectively, associated with the build material, an extrusion assembly, or a combination thereof at one or more locations of the extrusion assembly relative to a melting zone and (ii) a target output flow, the input control value enabling the output flow to match the target output flow.

22. The method of claim 21, further comprising deforming the build material, irreversibly, within the melting zone by increasing a temperature of the build material.

23. The method of claim 21, further comprising setting the input control value to an input flow value or an input pressure value.

24. The method of claim 21, further comprising representing each of the hydraulic resistance values by a respective change in pressure per change in flow rate of the build material at a respective location relative to the melting zone.

25. The method of claim 21, further comprising representing each of the hydraulic capacitance values by a respective first amount of build material stored in the extrusion assembly per a second amount of pressure applied to the extrusion assembly at a respective location relative to the melting zone.

26. The method of claim 21, further comprising configuring the hydraulic capacitance values to include a first hydraulic capacitance value and a second hydraulic capacitance value, the first hydraulic capacitance value representing a first hydraulic capacitance of the extrusion assembly and the build material in a solid form prior to an entrance of the melting zone, the second hydraulic capacitance value representing a second hydraulic capacitance of the extrusion assembly and the build material in a melted or partially melted form within the melting zone.

27. The method of claim 21, further comprising configuring the hydraulic resistance values to include a first resistance value, a second resistance value, and a third resistance value, the first resistance value representing a first resistance of the build material in a first melted or partially melted form within the melting zone, the second resistance value representing a second resistance of the build material in a second melted or partially melted form further within the melting zone and closer to an exit of the melting zone relative to the first resistance, the third resistance value representing a third resistance of the build material in a third melted or partially melted form following the exit of the melting zone and outside of the extrusion head.

28. The method of claim 21, wherein the hydraulic capacitance values and hydraulic resistance values are specific to at least one of: the extrusion assembly, a wetted geometry of the extrusion assembly, a characteristic of the build material, an ambient temperature surrounding and external to the extrusion assembly, a temperature of the build material within the extrusion assembly, a length of the build material in a solid form between the at least one actuator and the melting zone to be extruded from the extrusion assembly, or a diameter of the build material to be extruded from the extrusion assembly.

29. The method of claim 21, further comprising associating the hydraulic capacitance values and the hydraulic resistance values with capacitive and resistive elements, respectively, in a hydraulic circuit model.

30. The method of claim 21, further comprising determining the hydraulic resistance values based on measuring an efflux of mass or volume of the build material and a pressure within the extrusion assembly at a fixed set temperature and forcing condition applied to the build material.

31. The method of claim 21, further comprising determining the hydraulic resistance values based on measuring a pressure within the extrusion assembly at a fixed set temperature and constant rates of influx of mass or volume of the build material.

32. The method of claim 21, further comprising determining the hydraulic capacitance values based on a measured line width of the build material produced along a build plate in response to a commanded variation of the output flow.

33. The method of claim 21, further comprising determining the hydraulic capacitance values prior to, during, or after printing of the 3D object.

34. The method of claim 21, further comprising determining the hydraulic resistance values prior to, during, or after printing of the 3D object.

35. The method of claim 21, further comprising configuring the extrusion head to heat the build material within the melting zone via at least one heating element coupled to the extrusion head or via friction.

36. The method of claim 21, wherein the controlling includes receiving a real-time measurement of the extrusion assembly and adjusting the input control value based on the real-time measurement received, wherein the real-time measurement received includes a flow measurement, pressure measurement, printed line width measurement, or a combination thereof.

37. The method of claim 21, wherein the controlling includes receiving a commanded profile for extruding the build material along a build surface and modifying the commanded profile based on a hydraulic circuit model of the extrusion assembly, application of the hydraulic capacitance values, the hydraulic resistance values, a target output flow to the hydraulic circuit model, and real-time data of the extrusion assembly.

38. The method of claim 21, wherein the controlling includes receiving at least one toolpath command for controlling movement of the extrusion assembly along the build plate and adjusting the at least one toolpath command based on the input control value.

39. A system for producing a three-dimensional (3D) object, the system comprising:
means for controlling at least one actuator of an extrusion assembly to supply a build material to an extrusion head of the extrusion assembly based on an input control value; and
means for heating the build material within a melting zone of the extrusion head prior to extruding an output flow of the build material to produce the 3D object, the input control value being a function of (i) a hydraulic capacitance and a hydraulic resistance, representing hydraulic capacitance values and hydraulic resistance values, respectively, associated with the build material, an extrusion assembly, or a combination thereof at one or more locations of the extrusion assembly relative to the melting zone and (ii) a target output flow, the input control value enabling the output flow to match the target output flow.
